(19) United States
(12) Patent Application Publication
(10) Pub. No.: US 2025/0089961 A1
(43) Pub. Date: Mar. 20, 2025

(54) CLEANER SYSTEM AND CONTROL METHOD THEREOF

(71) Applicant: LG Electronics Inc., Seoul (KR)

(72) Inventors: Kyeongho CHO, Seoul (KR); Kietak HYUN, Seoul (KR); Jongil PARK, Seoul (KR); Hyunsup SONG, Seoul (KR)

(21) Appl. No.: 18/727,896

(22) PCT Filed: Jan. 10, 2023
(86) PCT No.: PCT/KR2023/000420

§ 371 Date: Jul. 10, 2024

Related U.S. Application Data
(60) Provisional application No. 63/297,872, filed on Jan. 10, 2022.

(30) Foreign Application Priority Data
May 23, 2022 (KR) 10-2022-0062891

(51) Int. Cl. A47L 9/14; A47L 9/00; F26B 3/04

(52) U.S. Cl. CPC A47L 9/149; A47L 9/0063; F26B 3/04

(57) ABSTRACT

The present disclosure relates to a cleaner system and a method of controlling the same, the cleaner system including a cleaner including a dust bin, and a suction part configured to guide outside air containing dust into the dust bin, a cleaner station including a housing in which a coupling part onto which the cleaner is seated and coupled is disposed, a dust collecting part configured to capture dust in the dust bin, a flow path part configured to connect the dust collecting part and a dust passage hole formed in the coupling part, a dust collecting motor configured to generate a suction force so that the dust is introduced into the dust collecting part through the flow path part, and a discharge part configured to guide air, which is discharged from the dust collecting motor, to the outside of the housing, and a heat supply part configured to supply heat to the suction part, thereby maintaining a clean, hygienic state of an interior of the dust collecting part.

### TECHNICAL FIELD

The present disclosure relates to a cleaner system and a method of controlling the same, and more particularly, to a cleaner system and a method of controlling the same, which are capable of maintaining a clean, hygienic state by drying a dust collecting part of a cleaner station.

### BACKGROUND ART

In general, a cleaner refers to an electrical appliance that draws in small garbage or dust by sucking air using electricity and fills a dust bin provided in a product with the garbage or dust. Such a cleaner is generally called a vacuum cleaner.

The cleaners may be classified into a manual cleaner which is moved directly by a user to perform a cleaning operation, and an automatic cleaner which performs a cleaning operation while autonomously traveling. Depending on the shape of the cleaner, the manual cleaners may be classified into a canister cleaner, an upright cleaner, a handy cleaner, a stick cleaner, and the like.

The canister cleaners were widely used in the past as household cleaners. However, recently, there is an increasing tendency to use the handy cleaner and the stick cleaner in which a dust bin and a cleaner main body are integrally provided to improve convenience of use.

In the case of the canister cleaner, a main body and a suction port are connected by a rubber hose or pipe, and in some instances, the canister cleaner may be used in a state in which a brush is fitted into the suction port.

The handy cleaner (hand vacuum cleaner) has maximized portability and is light in weight. However, because the handy cleaner has a short length, there may be a limitation to a cleaning region. Therefore, the handy cleaner is used to clean a local place such as a desk, a sofa, or an interior of a vehicle.

A user may use the stick cleaner while standing and thus may perform a cleaning operation without bending his/her waist. Therefore, the stick cleaner is advantageous for the user to clean a wide region while moving in the region. The handy cleaner may be used to clean a narrow space, whereas the stick cleaner may be used to clean a wide space and also used to a high place that the user's hand cannot reach. Recently, modularized stick cleaners are provided, such that types of cleaners are actively changed and used to clean various places.

However, because the handy cleaner or the stick cleaner in the related art has a dust bin with a small capacity for storing collected dust, which inconveniences the user because the user needs to empty the dust bin frequently.

In addition, because the dust scatters during the process of emptying the dust bin, there is a problem in that the scattering dust has a harmful effect on the user's health.

In addition, if residual dust is not removed from the dust bin, there is a problem in that a suction force of the cleaner deteriorates.

In addition, if the residual dust is not removed from the dust bin, there is a problem in that the residual dust causes an offensive odor.

As a document in the related art, Korean Patent No. 10-2315412 B1 discloses a cleaning apparatus including a vacuum cleaner and a docking station and a method of controlling the same.

The cleaning apparatus disclosed in the above-mentioned document in the related art includes the vacuum cleaner including a dust collecting container, and the docking station connected to the dust collecting container, and the dust collecting container is provided to be docked to the docking station. The docking station includes a control unit configured to irregularly change a suction airflow to be supplied to the dust collecting container.

However, in the cleaning apparatus in the above-mentioned document in the related art, a state in which foreign substances are captured in a capturing part may be maintained over a long period of time, which may cause the growth of insects, microorganisms, and the like. In particular, mites such as grain mites are microorganisms that live on insufficiently dried grain as parasites. In case that grain is captured in the capturing part in a high-temperature, humid environment, there is a problem in that the grain mites may easily grow, move along a flow path of the docking station to the outside.

Meanwhile, in the above-mentioned document in the related art, a flow rate adjustment device may be provided. The flow rate adjustment device is configured to increase a dust collecting force by increasing a flow rate in the dust collecting container by additionally supplying air into the dust collecting container of the cleaner. However, the flow rate adjustment device does not have an effect of maintaining a clean, hygienic state by drying an interior of the dust collecting part.

### DISCLOSURE

### Technical Problem

The present disclosure has been made in an effort to solve the above-mentioned problem with a cleaner system and a method of controlling the same in the related art, and an object of the present disclosure is to provide a cleaner system and a method of controlling the same, which are capable of removing dust in a dust bin without a user's separate operation, thereby providing convenience for a user.

The present disclosure has also been made in an effort to provide a cleaner system and a method of controlling the same, which are capable of maintaining a clean, hygienic state by drying an interior of a dust collecting part in which dust is captured.

The present disclosure has also been made in an effort to provide a cleaner system and a method of controlling the same, which are capable of preventing the occurrence of offensive odors caused by the decay of foreign substances and the like in a dust collecting part.

The present disclosure has also been made in an effort to provide a cleaner system and a method of controlling the same, which are capable of preventing the growth of insects and microorganisms such as grain mites in a dust collecting part.

### Technical Solution

In order to achieve the above-mentioned objects, the present invention provides a cleaner system including: a cleaner including a dust bin, and a suction part configured to guide outside air containing dust into the dust bin; a cleaner station including a housing in which a coupling part onto which the cleaner is seated and coupled is disposed, a dust collecting part accommodated in the housing, disposed at a lower side of the coupling part, and configured to capture dust in the dust bin, a flow path part configured to connect the dust collecting part and a dust passage hole formed in the coupling part, a dust collecting motor disposed below the dust collecting part and configured to generate a suction force so that the dust is introduced into the dust collecting part through the flow path part, and a discharge part configured to guide air, which is discharged from the dust collecting motor, to the outside of the housing; and a heat supply part configured to supply heat to the suction part.

The heat supply part may include a heater coupled to the suction part and configured to heat outside air introduced into the suction part.

The heater may heat outside air introduced into the suction part in a state in which the dust collecting motor operates.

The heater may heat outside air introduced into the suction part in a state in which a door of the cleaner station is rotated and the dust passage hole is opened.

The heat supply part may include a circulation flow path module having one end configured to communicate with the suction part, and the other end configured to communicate with the discharge part, such that the heat supply part guides at least a part of air, which is to be discharged to the outside of the housing through the discharge part, to the suction part.

In order to achieve the above-mentioned objects, the present disclosure provides a method of controlling a cleaner system, the method including: a door opening step of opening a dust passage hole by rotating a door of a cleaner station to which a cleaner is coupled; and a drying step of drying a dust collecting part of the cleaner station, in which dust is captured, by introducing air into the dust collecting part by operating a dust collecting motor of the cleaner station in a state in which the dust passage hole is opened.

A time for which the dust collecting motor operates in the drying step may be set to be longer than a time for which the dust collecting motor operates in a dust collecting step of collecting dust in a dust bin of the cleaner.

A rotational speed of the dust collecting motor in the drying step may be set to be equal to a rotational speed of the dust collecting motor in a dust collecting step of collecting dust in a dust bin of the cleaner.

In the drying step, a heater, which heats outside air introduced into a suction part of the cleaner, may operate in a state in which the dust collecting motor operates.

In order to achieve the above-mentioned objects, the present disclosure provides a method of controlling a cleaner system, the method including: a dust bin fixing step of fixing a dust bin of a cleaner when the cleaner is coupled to a cleaner station; a door opening step of opening a dust passage hole by rotating a door of the cleaner station in a forward direction when the dust bin is fixed; a drying step of drying a dust collecting part of the cleaner station, in which dust is captured, by introducing air into the dust collecting part by operating a dust collecting motor of the cleaner station in a state in which the dust passage hole is opened; a door closing step of closing the dust passage hole by rotating the door in a reverse direction after an operation of the dust collecting motor ends after the dust collecting motor operates for a predetermined time; and a release step of releasing the dust bin when the door is closed.

### Advantageous Effects

According to the cleaner system and the method of controlling the same according to the present disclosure, it is possible to eliminate the inconvenience of the user having to empty the dust bin all the time.

In addition, the air, which is heated while passing through the heat supply part, is introduced into the dust collecting part in which dust is captured, thereby maintaining a clean, hygienic state of the interior of the dust collecting part.

In addition, the air, which is heated while passing through the dust collecting motor, is introduced into the dust collecting part in which dust is captured, thereby maintaining a clean, hygienic state of the interior of the dust collecting part.

In addition, it is possible to prevent the occurrence of offensive odors by drying the interior of the dust collecting part in which dust is captured.

In addition, it is possible to kill insects and microorganisms by drying the interior of the dust collecting part in which dust is captured.

### DESCRIPTION OF DRAWINGS

FIG. 1 is a perspective view of a cleaner system including a cleaner station and a cleaner according to an embodiment of the present disclosure.

FIG. 2 is a schematic view illustrating a configuration of the cleaner system according to the embodiment of the present disclosure.

FIGS. 3 and 4 are views for explaining the cleaner of the cleaner system according to the embodiment of the present disclosure.

FIG. 5 is a view for explaining a lower side of a dust bin of the cleaner according to the embodiment of the present disclosure.

FIG. 6 is a view for explaining a coupling part of the cleaner station according to the embodiment of the present disclosure.

FIG. 7 is an exploded perspective view for explaining a fixing unit of the cleaner station according to the embodiment of the present disclosure.

FIGS. 8 and 9 are views for explaining a relationship between the cleaner and a door unit in the cleaner station according to the embodiment of the present disclosure.

FIG. 10 is a view for explaining a relationship between the cleaner and a cover opening unit in the cleaner station according to the embodiment of the present disclosure.

FIG. 11 is a view for explaining a cleaner system according to a first embodiment of the present disclosure.

FIG. 12 is a view for explaining a cleaner system according to a second embodiment of the present disclosure.

FIG. 13 is a block diagram for explaining a control configuration of the cleaner system according to the embodiment of the present disclosure.

FIG. 14 is a flowchart for explaining a process of drying a dust collecting part in a method of controlling the cleaner system according to the embodiment of the present disclosure.

FIG. 15 is a view for explaining operations of motors in the method of controlling the cleaner system according to the embodiment of the present disclosure.

FIG. 16 is a view for explaining an airflow in a drying step of the method of controlling the cleaner system according to the embodiment of the present disclosure.

### MODE FOR INVENTION

Hereinafter, exemplary embodiments of the present disclosure will be described in detail with reference to the accompanying drawings.

The present disclosure may be variously modified and may have various embodiments, and particular embodiments illustrated in the drawings will be specifically described below. The description of the embodiments is not intended to limit the present disclosure to the particular embodiments, but it should be interpreted that the present disclosure is to cover all modifications, equivalents and alternatives falling within the spirit and technical scope of the present disclosure.

The terminology used herein is used for the purpose of describing particular embodiments only and is not intended to limit the present disclosure. Singular expressions may include plural expressions unless clearly described as different meanings in the context.

Unless otherwise defined, all terms used herein, including technical or scientific terms, may have the same meaning as commonly understood by those skilled in the art to which the present disclosure pertains. The terms such as those defined in a commonly used dictionary may be interpreted as having meanings consistent with meanings in the context of related technologies and may not be interpreted as ideal or excessively formal meanings unless explicitly defined in the present application.

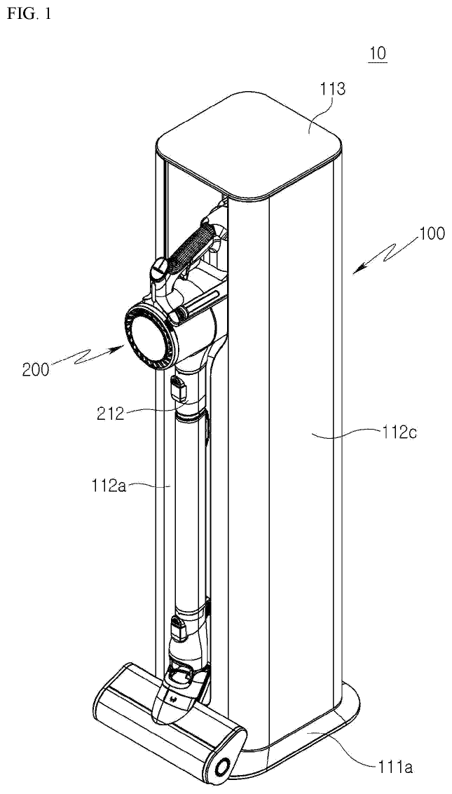

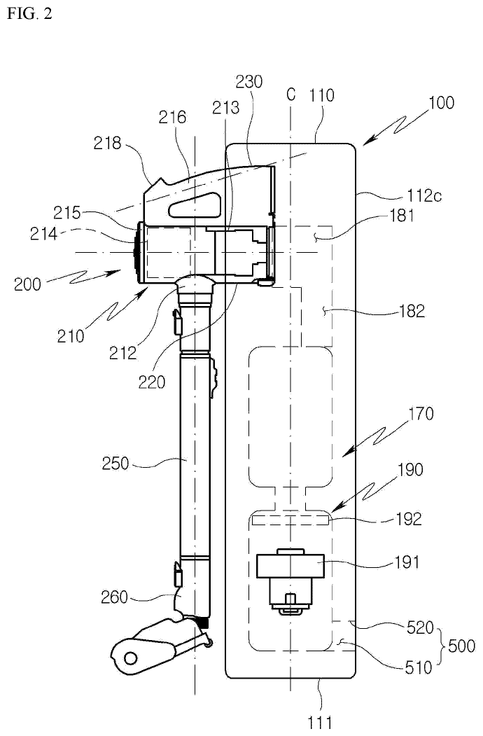

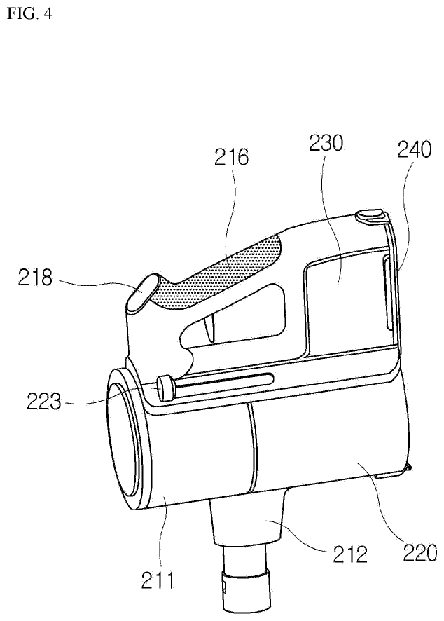

FIG. 1 is a perspective view illustrating a cleaner system including a cleaner station and a cleaner according to an embodiment of the present disclosure, and FIGS. 2 and 4 are schematic views illustrating configurations of the cleaner system according to various embodiments of the present disclosure.

With reference to FIGS. 1 and 2, a cleaner system 10 according to an embodiment of the present disclosure may include a cleaner station 100 and a cleaner 200.

The cleaner system 10 may include the cleaner station 100. The cleaner 200 may be coupled to the cleaner station 100. Specifically, the main body of the cleaner 200 may be coupled to the lateral surface of the cleaner station 100. The cleaner station 100 may remove dust from the dust bin 220 of the cleaner 200.

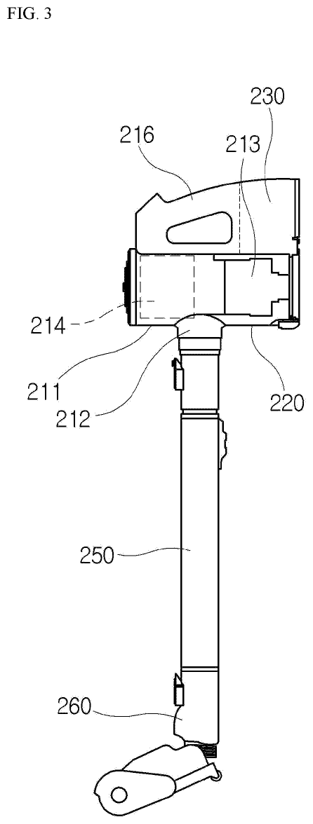

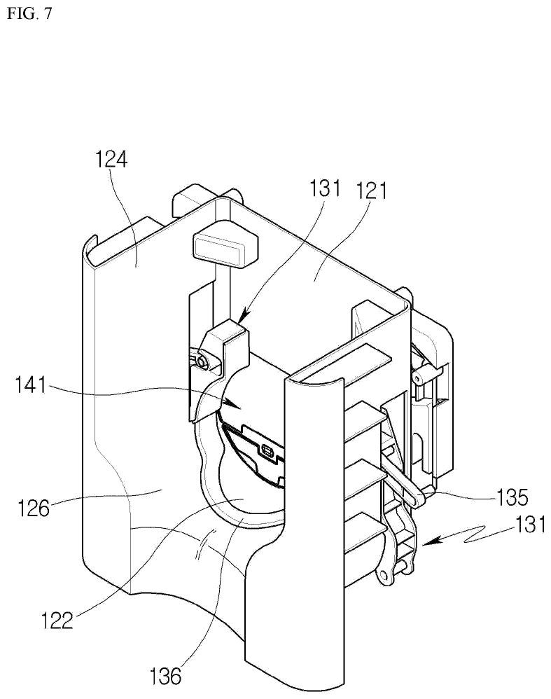

Meanwhile, FIGS. 3 and 4 are views for explaining the cleaner of the cleaner system according to the embodiment of the present disclosure, and FIG. 7 is a view for explaining the lower side of the dust bin of the cleaner according to the embodiment of the present disclosure.

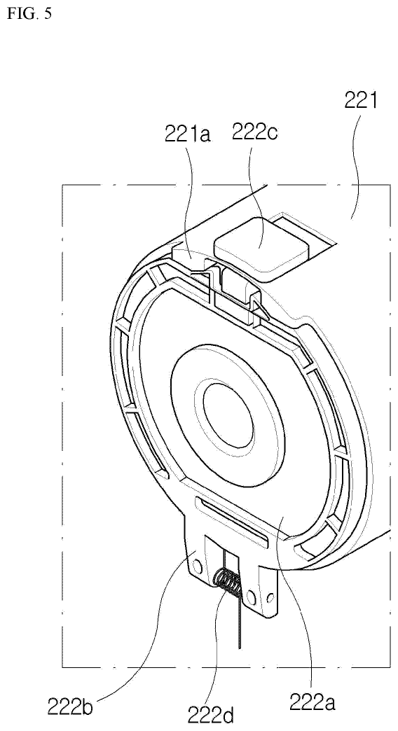

First, a structure of the cleaner 200 will be described below with reference to FIGS. 1 to 5.

The cleaner 200 may mean a cleaner configured to be manually operated by the user. For example, the cleaner 200 may mean a handy cleaner or a stick cleaner.

The cleaner 200 may be mounted on the cleaner station 100. The cleaner 200 may be supported by the cleaner station 100. The cleaner 200 may be coupled to the cleaner station 100.

Meanwhile, in the embodiment of the present disclosure, directions of the cleaner 200 may be defined on the basis of when a bottom surface (lower surface) of the dust bin 220 and a bottom surface (lower surface) of a battery housing 230 are placed on the ground surface.

In this case, a forward direction may mean a direction in which a suction part 212 is disposed based on a suction motor 214, and a rearward direction may mean a direction in which a handle 216 is disposed based on the suction motor 214. Further, based on a state in which the suction part 212 is viewed from the suction motor 214, a rightward direction may refer to a direction in which a component is disposed at the right, and a left direction may refer to a direction in which a component is disposed at the left. In addition, in the embodiment of the present disclosure, upper and lower sides may be defined in a direction perpendicular to the ground surface based on the state in which the bottom surface (lower surface) of the dust bin 220 and the bottom surface (lower surface) of the battery housing 230 are placed on the ground surface.

The cleaner 200 may include a main body 210. The main body 210 may include a main body housing 211, the suction part 212, a dust separating part 213, the suction motor 214, an air discharge cover 215, the handle 216, and an operating part 218.

The main body housing 211 may define an external appearance of the cleaner 200. The main body housing 211 may provide a space that may accommodate the suction motor 214 and a filter (not illustrated) therein. The main body housing 211 may be formed in a shape similar to a cylindrical shape.

The suction part 212 may protrude outward from the main body housing 211. For example, the suction part 212 may be formed in a cylindrical shape with an opened inside. The suction part 212 may be coupled to an extension tube 250. The suction part 212 may provide a suction flow path 2121 in which air containing dust may flow.

Meanwhile, in the present embodiment, an imaginary line may be defined to penetrate the inside of the suction part 212 having a cylindrical shape.

The dust separating part 213 may communicate with the suction part 212. The dust separating part 213 may separate dust sucked into the dust separating part 213 through the suction part 212. A space in the dust separating part 213 may communicate with a space in the dust bin 220.

For example, the dust separating part 213 may have one or more cyclone parts capable of separating dust by using a cyclone flow. Further, the space in the dust separating part 213 may communicate with the suction flow path 2121. Therefore, air and dust, which are sucked through the suction part 212, spirally flow along an inner circumferential surface of the dust separating part 213. Therefore, the cyclone flow may be generated in an internal space of the dust separating part 213.

The dust separating part 213 communicates with the suction part 212. The dust separating part 213 adopts a principle of a dust collector using a centrifugal force to separate the dust sucked into the main body 210 through the suction part 212.

The dust separating part 213 may further include a secondary cyclone part configured to separate again dust from the air discharged from the cyclone part. In this case, the secondary cyclone part may be positioned in the cyclone part to minimize a size of the dust separating part. The secondary cyclone part may include a plurality of cyclone bodies disposed in parallel. The air discharged from the cyclone part may be distributed to and pass through the plurality of cyclone bodies.

In this case, an axis of a cyclone flow of the secondary cyclone part may also extend in an upward/downward direction. The axis of the cyclone flow of the cyclone part and the axis of the cyclone flow of the secondary cyclone part may be disposed coaxially in the upward/downward direction and collectively called an axis of the cyclone flow of the dust separating part 213.

The suction motor 214 may generate a suction force for sucking air. The suction motor 214 may be accommodated in the main body housing 211. The suction motor 214 may generate the suction force while rotating. For example, the suction motor 214 may be formed in a shape similar to a cylindrical shape.

Meanwhile, in the present embodiment, an imaginary suction motor axis may be formed by extending a rotation axis of the suction motor 214.

The air discharge cover 215 may be disposed at one side of the main body housing 211 based on an axial direction. The air discharge cover 215 may accommodate the filter for filtering air. For example, an HEPA filter may be accommodated in the air discharge cover 215.

The air discharge cover 215 may have an air discharge port 215a for discharging the air introduced by the suction force of the suction motor 214.

A flow guide may be disposed on the air discharge cover 215. The flow guide may guide a flow of the air to be discharged through the air discharge port 215a.

The handle 216 may be gripped by the user. The handle 216 may be disposed rearward of the suction motor 214. For example, the handle 216 may be formed in a shape similar to a cylindrical shape. Alternatively, the handle 216 may be formed in a curved cylindrical shape. The handle 216 may be disposed at a predetermined angle with respect to the main body housing 211, the suction motor 214, or the dust separating part 213.

The handle 216 may include a grip portion formed in a column shape so that the user may grasp the grip portion, a first extension portion connected to one end of the grip portion based on the longitudinal direction (axial direction) of the grip portion and extending toward the suction motor 214, and a second extension portion connected to the other end of the grip portion based on the longitudinal direction (axial direction) of the grip portion and extending toward the dust bin 220.

Meanwhile, in the present embodiment, an imaginary grip portion through line may be formed to extend in the longitudinal direction of the grip portion (the axial direction of the column) and penetrate the grip portion.

For example, the grip portion through line may be an imaginary line formed in the handle 216 having a cylindrical shape, that is, an imaginary line formed in parallel with at least a part of an outer surface (outer circumferential surface) of the grip portion.

An upper side of the handle 216 may define an external appearance of a part of an upper side of the cleaner 200. Therefore, it is possible to prevent a component of the cleaner 200 from coming into contact with the user's arm when the user grips the handle 216.

The first extension portion may extend from the grip portion toward the main body housing 211 or the suction motor 214. At least a part of the first extension portion may extend in a horizontal direction.

The second extension portion may extend from the grip portion toward the dust bin 220. At least a part of the second extension portion may extend in the horizontal direction.

The operating part 218 may be disposed on the handle 216. The operating part 218 may be disposed on an inclined surface formed in an upper region of the handle 216. The user may input a command for operating or stopping the cleaner 200 through the operating part 218.

The cleaner 200 may include the dust bin 220. The dust bin 220 may communicate with the dust separating part 213. The dust bin 220 may store the dust separated by the dust separating part 213.

The dust bin 220 may include a dust bin main body 221, a discharge cover 222, a dust bin compression lever 223, and a compression member (not illustrated).

The dust bin main body 221 may provide a space capable of storing the dust separated by the dust separating part 213. For example, the dust bin main body 221 may be formed in a shape similar to a cylindrical shape.

Meanwhile, in the present embodiment, an imaginary dust bin through line may be formed to penetrate the inside (internal space) of the dust bin main body 221 and extend in the longitudinal direction of the dust bin main body 221 (that means the axial direction of the cylindrical dust bin main body 221).

A part of a lower side (bottom side) of the dust bin main body 221 may be opened. In addition, a lower extension portion 221a may be formed at the lower side (bottom side) of the dust bin main body 221. The lower extension portion 221a may be formed to block a part of the lower side of the dust bin main body 221.

The dust bin 220 may include the discharge cover 222. The discharge cover 222 may be disposed at a lower side of the dust bin 220.

The discharge cover 222 may be provided to open or close one end of the dust bin main body 221 based on the longitudinal direction. Specifically, the discharge cover 222 may selectively open or close the lower side of the dust bin 220 that is opened downward.

The discharge cover 222 may include a cover main body 222a and a hinge part 222b. The cover main body 222a may be formed to block a part of the lower side of the dust bin main body 221. The cover main body 222a may rotate downward relative to the hinge portion 222b. The hinge part 222b may be disposed adjacent to the battery housing 230. The hinge part 222b may have a torsion spring 222d. Therefore, when the discharge cover 222 is separated from the dust bin main body 221, an elastic force of the torsion spring 222d may support the cover main body 222a in a state in which the cover main body 222a is rotated by a predetermined angle or more about the hinge part 222b with respect to the dust bin main body 221.

The discharge cover 222 may be coupled to the dust bin 220 by a hook engagement. Meanwhile, the discharge cover 222 may be separated from the dust bin 220 by means of a coupling lever 222c. The coupling lever 222c may be disposed at a front side of the dust bin. Specifically, the coupling lever 222c may be disposed on an outer surface at the front side of the dust bin 220. When an external force is applied, the coupling lever 222c may elastically deform a hook, which extends from the cover main body 222a, in order to release the hook engagement between the cover main body 222a and the dust bin main body 221.

When the discharge cover 222 is closed, the lower side of the dust bin 220 may be blocked (sealed) by the discharge cover 222 and the lower extension portion 221a.

The dust bin 220 may include the dust bin compression lever 223 (see FIG. 4). The dust bin compression lever 223 may be disposed outside the dust bin 220 or the dust separating part 213. The dust bin compression lever 223 may be disposed outside the dust bin 220 or the dust separating part 213 so as to be movable upward and downward. The dust bin compression lever 223 may be connected to the compression member (not illustrated). When the dust bin compression lever 223 is moved downward by an external force, the compression member (not illustrated) may also be moved downward. Therefore, it is possible to provide convenience for the user. The compression member (not illustrated) and the dust bin compression lever 223 may return back to original positions by an elastic member (not illustrated). Specifically, when the external force applied to the dust bin compression lever 223 is eliminated, the elastic member may move the dust bin compression lever 223 and the compression member (not illustrated) upward.

The compression member (not illustrated) may be disposed in the dust bin main body 221. The compression member may move in the internal space of the dust bin main body 221. Specifically, the compression member may move upward and downward in the dust bin main body 221. Therefore, the compression member may compress downward the dust in the dust bin main body 221. In addition, when the discharge cover 222 is separated from the dust bin main body 221 and thus the lower side of the dust bin 220 is opened, the compression member may move from an upper side of the dust bin 220 to the lower side of the of the dust bin 220, thereby removing debris such as residual dust in the dust bin 220. Therefore, it is possible to improve the suction force of the cleaner by preventing the residual dust from remaining in the dust bin 220. Further, it is possible to remove an offensive odor caused by the residual dust by preventing the residual dust from remaining in the dust bin 220.

The cleaner 200 may include the battery housing 230. A battery 240 may be accommodated in the battery housing 230. The battery housing 230 may be disposed below the handle 216. For example, the battery housing 230 may have a hexahedral shape opened at a lower side thereof. A rear side of the battery housing 230 may be connected to the handle 216.

The battery housing 230 may include an accommodation portion opened downward. The battery 240 may be attached or detached through the accommodation portion of the battery housing 230.

The cleaner 200 may include the battery 240.

For example, the battery 240 may be separably coupled to the cleaner 200. The battery 240 may be separably coupled to the battery housing 230. For example, the battery 240 may be inserted into the battery housing 230 from the lower side of the battery housing 230. With this configuration, the portability of the cleaner 200 may be improved.

On the contrary, the battery 240 may be integrally provided in the battery housing 230. In this case, a lower surface of the battery 240 is not exposed to the outside.

The battery 240 may supply power to the suction motor 214 of the cleaner 200. The battery 240 may be disposed below the handle 216. The battery 240 may be disposed at a rear side of the dust bin 220.

In case that the battery 240 is coupled to the battery housing 230 in accordance with the embodiment, the lower surface of the battery 240 may be exposed to the outside. Because the battery 240 may be placed on the floor when the cleaner 200 is placed on the floor, the battery 240 may be immediately separated from the battery housing 230. In addition, because the lower side of the battery 240 is exposed to the outside and thus in direct contact with the air present outside the battery 240, the performance in cooling the battery 240 may be improved.

Meanwhile, in case that the battery 240 is fixed integrally to the battery housing 230, the number of structures for attaching or detaching the battery 240 and the battery housing 230 may be reduced, and as a result, it is possible to reduce an overall size of the cleaner 200 and a weight of the cleaner 200.

The cleaner 200 may include the extension tube 250. The extension tube 250 may communicate with a cleaning module 260. The extension tube 250 may communicate with the main body 210. The extension tube 250 may communicate with the suction part 212 of the main body 210. The extension tube 250 may be formed in a long cylindrical shape.

The main body 210 may be connected to the extension tube 250. The main body 210 may be connected to the cleaning module 260 through the extension tube 250. The main body 210 may generate the suction force by means of the suction motor 214 and provide the suction force to the cleaning module 260 through the extension tube 250. The outside dust may be introduced into the main body 210 through the cleaning module 260 and the extension tube 250.

The cleaner 200 may include the cleaning module 260. The cleaning module 260 may communicate with the extension tube 250. Therefore, the outside air may be introduced into the main body 210 of the cleaner 200 via the cleaning module 260 and the extension tube 250 by the suction force generated in the main body 210 of the cleaner 200.

The dust in the dust bin 220 of the cleaner 200 may be captured by a dust collecting part 170 of the cleaner station 100 by gravity and a suction force of a dust collecting motor 191. Therefore, it is possible to remove the dust in the dust bin without the user's separate manipulation, thereby providing convenience for the user. In addition, it is possible to eliminate the inconvenience of the user having to empty the dust bin all the time. In addition, it is possible to prevent the dust from scattering when emptying the dust bin.

The cleaner 200 may be coupled to a lateral surface of a housing 110. Specifically, the main body 210 of the cleaner 200 may be mounted on a coupling part 120. More specifically, the dust bin 220 and the battery housing 230 of the cleaner 200 may be coupled to a coupling surface 121, an outer circumferential surface of the dust bin main body 221 may be coupled to a dust bin guide surface 122, and the suction part 212 may be coupled to a suction part guide surface 126 of the coupling part 120. In this case, a central axis of the dust bin 220 may be disposed in a direction parallel to the ground surface, and the extension tube 250 may be disposed in a direction perpendicular to the ground surface.

The cleaner station 100 of the present disclosure will be described below with reference to FIGS. 1 and 2.

The cleaner 200 may be disposed in the cleaner station 100. The cleaner 200 may be coupled to a lateral side of the cleaner station 100. Specifically, the main body of the cleaner 200 may be coupled to the lateral surface of the cleaner station 100. The cleaner station 100 may remove dust from the dust bin 220 of the cleaner 200.

The cleaner station 100 may include the housing 110. The housing 110 may define an external appearance of the cleaner station 100. Specifically, the housing 110 may be provided in the form of a column including one or more outer wall surfaces. For example, the housing 110 may be formed in a shape similar to a quadrangular column.

The housing 110 may have a space capable of accommodating the dust collecting part 170 configured to store dust therein, and a dust suction module 190 configured to generate a flow force for collecting the dust in the dust collecting part 170.

The housing 110 may include a bottom surface 111, an outer wall surface 112, and an upper surface 113.

The bottom surface 111 may support a lower side of the dust suction module 190 based on the gravitational direction. That is, the bottom surface 111 may support a lower side of the dust collecting motor 171 of the dust suction module 190.

In this case, the bottom surface 111 may be disposed toward the ground surface. The bottom surface 111 may also be disposed in parallel with the ground surface or disposed to be inclined at a predetermined angle with respect to the ground surface. The above-mentioned configuration may be advantageous in stably supporting the dust collecting motor 171 and maintaining balance of an overall weight even in a case in which the cleaner 200 is coupled.

Meanwhile, according to the embodiment, the bottom surface 111 may further include a ground surface support portion 111a in order to prevent the cleaner station 100 from falling down and increase an area being in contact with the ground surface to maintain the balance. For example, the ground surface support portion may have a plate shape extending from the bottom surface 111, and one or more frames may protrude and extend from the bottom surface 111 in a direction of the ground surface.

The outer wall surface 112 may mean a surface formed in the gravitational direction or a surface connected to the bottom surface 111. For example, the outer wall surface 112 may mean a surface connected to the bottom surface 111 so as to be perpendicular to the bottom surface 111. As another embodiment, the outer wall surface 112 may be disposed to be inclined at a predetermined angle with respect to the bottom surface 111.

The outer wall surface 112 may include at least one surface. For example, the outer wall surface 112 may include a first outer wall surface 112a, a second outer wall surface 112b, a third outer wall surface 112c, and a fourth outer wall surface 112d.

In this case, in the present embodiment, the first outer wall surface 112a may be disposed at the front side of the cleaner station 100. In this case, the front side may mean a side at which the cleaner 200 is exposed in the state in which the cleaner 200 is coupled to the cleaner station 100. Therefore, the first outer wall surface 112a may define an external appearance of the front side of the cleaner station 100.

Meanwhile, the directions are defined as follows to understand the present embodiment. In the present embodiment, the directions may be defined in the state in which the cleaner 200 is mounted on the cleaner station 100.

In the state in which the cleaner 200 is mounted on the cleaner station 100, a direction in which the cleaner 200 is exposed to the outside of the cleaner station 100 may be referred to as a forward direction.

In another point of view, in the state in which the cleaner 200 is mounted on the cleaner station 100, a direction in which the suction motor 214 of the cleaner 200 is disposed may be referred to as the forward direction. Further, a direction opposite to the direction in which the suction motor 214 is disposed on the cleaner station 100 may be referred to as a rearward direction.

Further, based on the internal space of the housing 110, a surface facing the front surface may be referred to as a rear surface of the cleaner station 100. Therefore, the rear surface may mean a direction in which the second outer wall surface 112b is formed.

Further, based on the internal space of the housing 110, a left surface when viewing the front surface may be referred to as a left surface, and a right surface when viewing the front surface may be referred to as a right surface. Therefore, the left surface may mean a direction in which the third outer wall surface 112c is formed, and the right surface may mean a direction in which the fourth outer wall surface 112d is formed.

The first outer wall surface 112a may be formed in the form of a flat surface, or the first outer wall surface 112a may be formed in the form of a curved surface as a whole or formed to partially include a curved surface.

The first outer wall surface 112a may have an external appearance corresponding to the shape of the cleaner 200. In detail, the coupling part 120 may be disposed on the first outer wall surface 112a. With this configuration, the cleaner 200 may be coupled to the cleaner station 100 and supported by the cleaner station 100. The specific configuration of the coupling part 120 will be described below.

Meanwhile, a structure for mounting various types of cleaning modules 260 used for the cleaner 200 may be additionally provided on the first outer wall surface 112a.

In the present embodiment, the second outer wall surface 112b may be a surface facing the first outer wall surface 112a. That is, the second outer wall surface 112b may be disposed on the rear surface of the cleaner station 100. In this case, the rear surface may be a surface facing the surface to which the cleaner 200 is coupled. Therefore, the second outer wall surface 112b may define an external appearance of the rear surface of the cleaner station 100.

For example, the second outer wall surface 112b may be formed in the form of a flat surface. With this configuration, the cleaner station 100 may be in close contact with a wall in a room, and the cleaner station 100 may be stably supported.

As another example, the structure for mounting various types of cleaning modules 260 used for the cleaner 200 may be additionally provided on the second outer wall surface 112b.

In the present embodiment, the third outer wall surface 112c and the fourth outer wall surface 112d may mean surfaces that connect the first outer wall surface 112a and the second outer wall surface 112b. In this case, the third outer wall surface 112c may be disposed on the left surface of the station 100, and the fourth outer wall surface 112d may be disposed on the right surface of the cleaner station 100. On the contrary, the third outer wall surface 112c may be disposed on the right surface of the cleaner station 100, and the fourth outer wall surface 112d may be disposed on the left surface of the cleaner station 100.

The third outer wall surface 112c or the fourth outer wall surface 112d may be formed in the form of a flat surface, or the third outer wall surface 112c or the fourth outer wall surface 112d may be formed in the form of a curved surface as a whole or formed to partially include a curved surface.

Meanwhile, the structure for mounting various types of cleaning modules 260 used for the cleaner 200 may be additionally provided on the third outer wall surface 112c or the fourth outer wall surface 112d.

The upper surface 113 may define an upper external appearance of the cleaner station. That is, the upper surface 113 may mean a surface disposed at an outermost side of the cleaner station in the gravitational direction and exposed to the outside.

For reference, in the present embodiment, the terms ‘upper side’ and ‘lower side’ may mean the upper and lower sides in the gravitational direction (a direction perpendicular to the ground surface) in the state in which the cleaner station 100 is installed on the ground surface.

In this case, the upper surface 113 may also be disposed in parallel with the ground surface or disposed to be inclined at a predetermined angle with respect to the ground surface.

A display part 410 may be disposed on the upper surface 113. For example, the display part 410 may display a state of the cleaner station 100 and a state of the cleaner 200. The display part may further display information such as a cleaning process situation, a map of the cleaning zone, and the like.

Meanwhile, according to the embodiment, the upper surface 113 may be separable from the outer wall surface 112. In this case, when the upper surface 113 is separated, the battery separated from the cleaner 200 may be accommodated in the internal space surrounded by the outer wall surface 112, and a terminal (not illustrated) capable of charging the separated battery may be provided in the internal space.

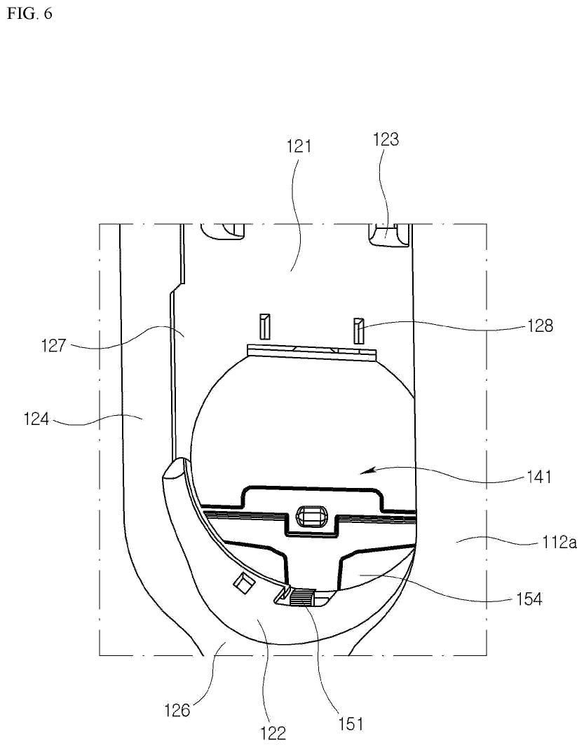

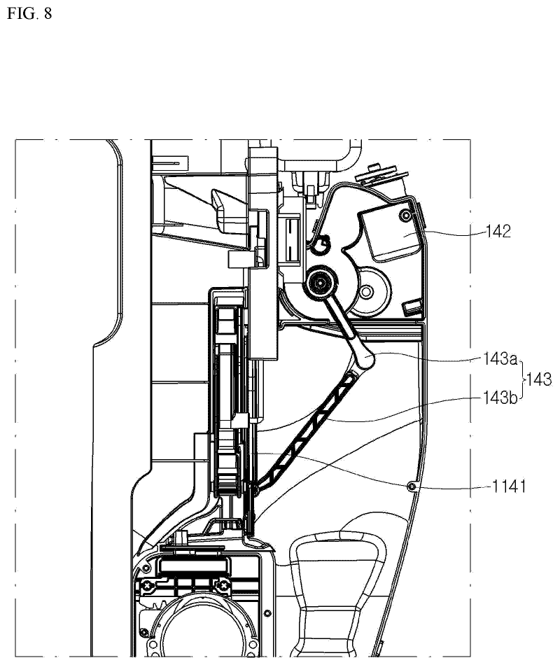

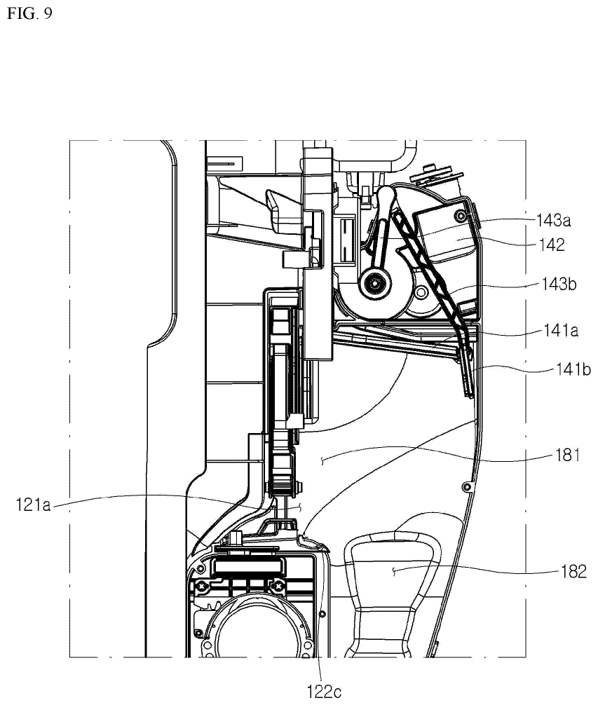

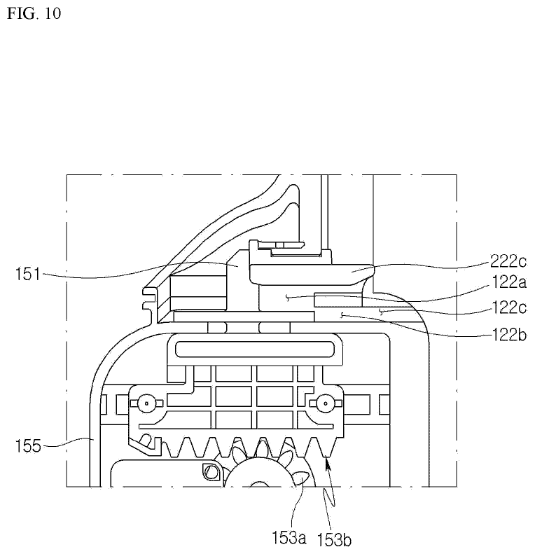

FIG. 6 is a view for explaining the coupling part of the cleaner station according to the embodiment of the present disclosure, FIG. 7 is a view for explaining a fixing unit of the cleaner station according to the embodiment of the present disclosure, FIGS. 8 and 9 are views for explaining a relationship between the cleaner and a door unit in the cleaner station according to the embodiment of the present disclosure, and FIG. 10 is a view for explaining a relationship between the cleaner and a cover opening unit in the cleaner station according to the embodiment of the present disclosure.

The coupling part 120 of the cleaner station 100 according to the present disclosure will be described below with reference to FIGS. 2 and 6.

The cleaner station 100 may include the coupling part 120 to which the cleaner 200 is coupled. Specifically, the coupling part 120 may be disposed in the first outer wall surface 112a, and the main body 210, the dust bin 220, and the battery housing 230 of the cleaner 200 may be coupled to the coupling part 120.

The coupling part 120 may include the coupling surface 121. The coupling surface 121 may be disposed on the lateral surface of the housing 110. For example, the coupling surface 121 may mean a surface formed in the form of a groove which is concave toward the inside of the cleaner station 100 from the first outer wall surface 112a. That is, the coupling surface 121 may mean a surface formed to have a stepped portion with respect to the first outer wall surface 112a.

The cleaner 200 may be coupled to the coupling surface 121. For example, the coupling surface 121 may be in contact with the lower surface of the dust bin 220 and the lower surface of the battery housing 230 of the cleaner 200. In this case, the lower surface may mean a surface directed toward the ground surface when the user uses the cleaner 200 or places the cleaner 200 on the ground surface.

For example, an angle of the coupling surface 121 with respect to the ground surface may be a right angle. Therefore, it is possible to minimize a space of the cleaner station 100 when the cleaner 200 is coupled to the coupling surface 121.

As another example, the coupling surface 121 may be disposed to be inclined at a predetermined angle with respect to the ground surface. Therefore, the cleaner station 100 may be stably supported when the cleaner 200 is coupled to the coupling surface 121.

The coupling part 120 may have a dust passage hole 121a through which air present outside the housing 110 may be introduced into the housing 110. Specifically, the dust passage hole 121a may be formed in the coupling surface 121 of the coupling part 120 so that outside air may be introduced into the housing 110. The dust passage hole 121a may be formed in the form of a hole corresponding to the shape of the dust bin 220 so that the dust in the dust bin 220 may be introduced into the dust collecting part 170. The dust passage hole 121a may be formed to correspond to the shape of the discharge cover 222 of the dust bin 220. The dust passage hole 121a may be formed to communicate with the flow path 180 to be described below.

The coupling part 120 may include the dust bin guide surface 122. The dust bin guide surface 122 may be disposed on the first outer wall surface 112a. The dust bin guide surface 122 may be connected to the first outer wall surface 112a. In addition, the dust bin guide surface 122 may be connected to the coupling surface 121.

The dust bin guide surface 122 may be formed in a shape corresponding to the outer surface of the dust bin 220. A front outer surface of the dust bin 220 may be coupled to the dust bin guide surface 122. Therefore, it is possible to provide the convenience when coupling the cleaner 200 to the coupling surface 121.

Meanwhile, a protrusion moving hole 122a may be formed in the dust bin guide surface 122, and a push protrusion 151 to be described below may rectilinearly move along the protrusion moving hole 122a. In addition, a gearbox 155 may be provided below the dust bin guide surface 122 based on the gravitational direction and accommodate a gear or the like of a cover opening unit 150 to be described below. In this case, a guide space 122b, through which the push protrusion 151 may move, may be formed between the dust bin guide surface 122, the lower surface, and the upper surface of the gearbox 155. Further, the guide space 122b may communicate with the flow path part 180 through a bypass hole 122c. That is, the protrusion moving hole 122a, the guide space 122b, the bypass hole 122c, and the flow path part 180 may define one bypass flow path (see FIG. 10). With this configuration, when the dust collecting motor 191 operates in the state in which the dust bin 220 is coupled to the coupling part 120, the dust or the like, which remains in the dust bin 220 and remains on the dust bin guide surface 122, may be sucked through the bypass flow path.

The coupling part 120 may include guide protrusions 123. The guide protrusions 123 may be disposed on the coupling surface 121. The guide protrusions 123 may protrude upward from the coupling surface 121. Two guide protrusions 123 may be disposed to be spaced apart from each other. A distance between the two guide protrusions 123, which are spaced apart from each other, may correspond to a width of the battery housing 230 of the cleaner 200. Therefore, it is possible to provide the convenience when coupling the cleaner 200 to the coupling surface 121.

The coupling part 120 may include sidewalls 124. The sidewalls 124 may mean wall surfaces disposed at two opposite sides of the coupling surface 121 and may be perpendicularly connected to the coupling surface 121. The sidewalls 124 may be connected to the first outer wall surface 112a. In addition, the sidewalls 124 may define surfaces connected to the dust bin guide surface 122. Therefore, the cleaner 200 may be stably accommodated.

The coupling part 120 may include a coupling sensor 125. The coupling sensor 125 may detect whether the cleaner 200 is coupled to the coupling part 120.

The coupling sensor 125 may include a contact sensor. For example, the coupling sensor 125 may include a micro-switch. In this case, the coupling sensor 125 may be disposed on the guide protrusion 123. Therefore, when the battery housing 230 or the battery 240 of the cleaner 200 is coupled between the pair of guide protrusions 123, the battery housing 230 or the battery 240 comes into contact with the coupling sensor 125, such that the coupling sensor 125 may detect that the cleaner 200 is coupled to the coupling part.

Meanwhile, the coupling sensor 125 may include a contactless sensor. For example, the coupling sensor 125 may include an infrared ray (IR) sensor. In this case, the coupling sensor 125 may be disposed on the sidewall 124. Therefore, when the dust bin 220 or the main body 210 of the cleaner 200 passes the sidewall 124 and then reaches the coupling surface 121, the coupling sensor 125 may detect the presence of the dust bin 220 or the main body 210.

The coupling sensor 125 may face the dust bin 220 or the battery housing 230 of the cleaner 200.

The coupling sensor 125 may be a mean for determining whether the cleaner 200 is coupled and power is applied to the battery 240 of the cleaner 200.

The coupling part 120 may include the suction part guide surface 126. The suction part guide surface 126 may be disposed on the first outer wall surface 112a. The suction part guide surface 126 may be connected to the dust bin guide surface 122. The suction part 212 may be coupled to the suction part guide surface 126. The suction part guide surface 126 may be formed in a shape corresponding to the shape of the suction part 212.

The coupling part 120 may further include a fixing member entrance hole 127. The fixing member entrance hole 127 may be formed in the form of a long hole along the sidewall 124 so that fixing members 131 may enter and exit the fixing member entrance hole 127.

With this configuration, when the user couples the cleaner 200 to the coupling part 120 of the cleaner station 100, the main body 210 of the cleaner 200 may be stably disposed on the coupling part 120 by the dust bin guide surface 122, the guide protrusions 123, and the suction part guide surface 126. Therefore, it is possible to provide convenience when coupling the dust bin 220 and the battery housing 230 of the cleaner 200 to the coupling surface 121.

A fixing unit 130 according to the present disclosure will be described below with reference to FIGS. 2 and 7.

The cleaner station 100 according to the present disclosure may include the fixing unit 130. The fixing unit 130 may be disposed on the sidewall 124. In addition, at least a part of the fixing unit 130 may be disposed on a back surface to the coupling surface 121. The fixing unit 130 may fix the cleaner 200 coupled to the coupling surface 121. Specifically, the fixing unit 130 may fix the dust bin 220 and the battery housing 230 of the cleaner 200 coupled to the coupling surface 121

The fixing unit 130 may include a fixing members 131 configured to fix the dust bin 220 and the battery housing 230 of the cleaner 200, and a fixing part motor 133 configured to operate the fixing members 131. In addition, the fixing unit 130 may further include fixing part links 135 configured to transmit power of the fixing part motor 133 to the fixing members 131.

The fixing members 131 may be disposed on the sidewall 124 of the coupling part 120 and provided on the sidewall 124 so as to reciprocate in order to fix the dust bin 220. Specifically, the fixing members 131 may be accommodated in the fixing member entrance hole 127.

The fixing members 131 may be disposed at two opposite sides of the coupling part 120, respectively. For example, a pair of two fixing members 131 may be symmetrically disposed with respect to the coupling surface 121.

The fixing part motor 133 may provide power for moving the fixing member 131.

The fixing part links 135 may convert a rotational force of the fixing part motor 133 into the reciprocations of the fixing members 131.

A stationary sealer 136 may be disposed on the dust bin guide surface 122 so as to seal the dust bin 220 when the cleaner 200 is coupled. With this configuration, when the dust bin 220 of the cleaner 200 is coupled, the cleaner 200 may press the stationary sealer 136 by its own weight, such that the dust bin 220 and the dust bin guide surface 122 may be sealed.

The stationary sealer 136 may be disposed on an imaginary extension line of the fixing member 131. With this configuration, when the fixing part motor 133 operates and the fixing members 131 press the dust bin 220, a circumference of the dust bin 220 at the same height may be sealed.

According to the embodiment, the stationary sealer 136 may be disposed on the dust bin guide surface 122 and formed in the form of a bent line corresponding to an arrangement of the cover opening unit 150 to be described below.

Therefore, when the main body 210 of the cleaner 200 is disposed on the coupling part 120, the fixing unit 130 may fix the main body 210 of the cleaner 200. Specifically, when the coupling sensor 125 detects that the main body 210 of the cleaner 200 is coupled to the coupling part 120 of the cleaner station 100, the fixing part motor 133 may move the fixing members 131 to fix the main body 210 of the cleaner 200.

Therefore, it is possible to improve the suction force of the cleaner by preventing the residual dust from remaining in the dust bin. Further, it is possible to remove an offensive odor caused by the residual dust by preventing the residual dust from remaining in the dust bin.

A door unit 140 according to the present disclosure will be described below with reference to FIGS. 2, 8, 9, and 13.

The cleaner station 100 according to the present disclosure may include the door unit 140. The door unit 140 may be configured to open or close the dust passage hole 121a.

The door unit 140 may include a door 141, a door motor 142, and a door arm 143.

The door 141 may be hingedly coupled to the coupling surface 121 and may open or close the dust passage hole 121a. The door 141 may include a door main body 141a.

The door main body 141a may be formed in a shape capable of blocking the dust passage hole 121a. For example, the door main body 141a may be formed in a shape similar to a circular plate shape.

Based on a state in which the door main body 141a blocks the dust passage hole 121a, the hinge part may be disposed at an upper side of the door main body 141a, and an arm coupling part 141b may be disposed at a lower side of the door main body 141a.

The door main body 141a may be formed in a shape capable of sealing the dust passage hole 121a. For example, an outer surface of the door main body 141a, which is exposed to the outside of the cleaner station 100, is formed to have a diameter corresponding to a diameter of the dust passage hole 121a, and an inner surface of the door main body 141a, which is disposed in the cleaner station 100, is formed to have a diameter greater than the diameter of the dust passage hole 121a. In addition, a level difference may be defined between the outer surface and the inner surface. Meanwhile, one or more reinforcing ribs may protrude from the inner surface of the door main body 141a in order to connect the hinge part and the arm coupling part 141b and reinforce a supporting force of the door main body 141a.

The hinge part may be a means by which the door 141 is hingedly coupled to the coupling surface 121. The hinge part may be disposed at an upper end of the door main body 141a and coupled to the coupling surface 121.

The arm coupling part 141b may be a means to which the door arm 143 is rotatably coupled. The arm coupling part 141b may be disposed at a lower side of the door main body 141a and rotatably coupled to the door main body 141a, and the door arm 143 may be rotatably coupled to the arm coupling part 141b.

With this configuration, when the door arm 143 pulls the door main body 141a in the state in which the door 141 closes the dust passage hole 121a, the door main body 141a is rotated about the hinge part toward the inside of the cleaner station 100, such that the dust passage hole 121a may be opened. Meanwhile, when the door arm 143 pushes the door main body 141a in the state in which the dust passage hole 121a is opened, the door main body 141a is rotated about the hinge part 141b toward the outside of the cleaner station 100, such that the dust passage hole 121a may be closed.

Meanwhile, the door 141 may be in contact with the discharge cover 222 in the state in which the cleaner 200 is coupled to the cleaner station 100 and the discharge cover 222 is separated from the dust bin main body 210. Further, when the door 141 rotates, the discharge cover 222 may rotate in conjunction with the door 141.

The door motor 142 may provide power for rotating the door 141. Specifically, the door motor 142 may rotate the door arm 143 in a forward or reverse direction. In this case, the forward direction may mean a direction in which the door arm 143 pulls the door 141. Therefore, when the door arm 143 is rotated in the forward direction, the dust passage hole 121a may be opened. In addition, the reverse direction may mean a direction in which the door arm 143 pushes the door 141. Therefore, when the door arm 143 is rotated in the reverse direction, at least a part of the dust passage hole 121a may be closed. The forward direction may be opposite to the reverse direction.

The door arm 143 may connect the door 141 and the door motor 142 and open or close the door 141 using the power generated from the door motor 142.

For example, the door arm 143 may include a first door arm 143a and the second door arm 143b. One end of the first door arm 143a may be coupled to the door motor 142. The first door arm 143a may be rotated by the power of the door motor 142. The other end of the first door arm 143a may be rotatably coupled to the second door arm 143b. The first door arm 143a may transmit a force transmitted from the door motor 142 to the second door arm 143b. One end of the second door arm 143b may be coupled to the first door arm 143a. The other end of the second door arm 143b may be coupled to the door 141. The second door arm 143b may open or close the dust passage hole 121a by pushing or pulling the door 141.

The door unit 140 may further include door opening/closing detecting parts 144. The door opening/closing detecting parts 144 may be provided in the housing 110 and may detect whether the door 141 is in an opened state.

For example, the door opening/closing detecting parts 144 may be disposed at both ends in a rotational region of the door arm 143, respectively. As another example, the door opening/closing detecting parts 144 may be disposed at both ends in a movement region of the door 141, respectively.

Therefore, when the door arm 143 is moved to a preset door opening position DP1 or when the door 141 is opened to a predetermined position, the door opening/closing detecting parts 144 may detect that the door is opened. In addition, when the door arm 143 is moved to a preset door closing position DP2 or when the door 141 is opened to a predetermined position, the door opening/closing detecting parts 144 may detect that the door is opened.

The door opening/closing detecting part 144 may include a contact sensor. For example, the door opening/closing detecting part 144 may include a micro-switch.

Meanwhile, the door opening/closing detecting part 144 may also include a contactless sensor. For example, the door opening/closing detecting part 144 may include an infrared ray (IR) sensor.

With this configuration, the door unit 140 may selectively open or close at least a part of the coupling surface 121, thereby allowing the outside of the first outer wall surface 112a to communicate with the flow path part 180 and/or the dust collecting part 170.

The door unit 140 may be opened when the discharge cover 222 of the cleaner 200 is opened. In addition, when the door unit 140 is closed, the discharge cover 222 of the cleaner 200 may also be closed in conjunction with the door unit 140.

When the dust in the dust bin 220 of the cleaner 200 is removed, the door motor 142 may rotate the door 141, thereby coupling the discharge cover 222 to the dust bin main body 221. Specifically, the door motor 142 may rotate the door 141 to rotate the door 141, and the rotating door 141 may push the discharge cover 222 toward the dust bin main body 221.

The cover opening unit 150 according to the present disclosure will be described below with reference to FIGS. 2, 10, and 13.

The cleaner station 100 according to the present disclosure may include the cover opening unit 150. The cover opening unit 150 may be disposed on the coupling part 120 and may open the discharge cover 222 of the cleaner 200.

The cover opening unit 150 may include the push protrusion 151, a cover opening motor 152, cover opening gears 153, a support plate 154, and the gear box 155.

The push protrusion 151 may move to press the coupling lever 222c when the cleaner 200 is coupled.

The push protrusion 151 may be disposed on the dust bin guide surface 122. Specifically, the protrusion moving hole may be formed in the dust bin guide surface 122, and the push protrusion 151 may be exposed to the outside by passing through the protrusion moving hole.

When the cleaner 200 is coupled, the push protrusion 151 may be disposed at a position at which the push protrusion 151 may push the coupling lever 222c. That is, the coupling lever 222c may be disposed on the protrusion moving hole. In addition, the coupling lever 222c may be disposed in a movement region of the push protrusion 151.

The push protrusion 151 may rectilinearly reciprocate to press the coupling lever 222c. Specifically, the push protrusion 151 may be coupled to the gear box 155, such that the rectilinear movement of the push protrusion 151 may be guided. The push protrusion 151 may be coupled to the cover opening gears 153 and moved together with the cover opening gears 153 by the movements of the cover opening gears 153.

The cover opening motor 152 may provide power for moving the push protrusion 151. Specifically, the cover opening motor 152 may rotate a motor shaft (not illustrated) in a forward direction or a reverse direction. In this case, the forward direction may mean a direction in which the push protrusion 151 pushes the coupling lever 222c. In addition, the reverse direction may mean a direction in which the push protrusion 151, which has pushed the coupling lever 222c, returns back to an original position. The forward direction may be opposite to the reverse direction.

The cover opening gears 153 may be coupled to the cover opening motor 152 and may move the push protrusion 151 using the power from the cover opening motor 152. Specifically, the cover opening gears 153 may be accommodated in the gear box 155. A driving gear 153a of the cover opening gears 153 may be coupled to the motor shaft of the cover opening motor 152 and supplied with the power. A driven gear 153b of the cover opening gears 153 may be coupled to the push protrusion 151 to move the push protrusion 151. For example, the driven gear 153b may be provided in the form of a rack gear, engage with the driving gear 153a, and receive power from the driving gear 153a.

In this case, the discharge cover 222 may have the torsion spring 222d. The discharge cover 222 may be rotated by a predetermined angle or more and supported in the rotated position by an elastic force of the torsion spring 222d. Therefore, the discharge cover 222 may be opened, and the dust passage hole 121a and the inside of the dust bin 220 may communicate with each other.

The gear box 155 may be disposed in the housing 110 and disposed at the lower side of the coupling part 120 in the gravitational direction, and the cover opening gears 153 may be accommodated in the gear box 155.

Cover opening detecting parts 155f may be disposed on the gear box 155. In this case, the cover opening detecting part 155f may include a contact sensor. For example, the cover opening detecting part 155f may include a micro-switch. Meanwhile, the cover opening detecting part 155f may also include a contactless sensor. For example, the cover opening detecting part 155f may include an infrared (IR) sensor.

The cover opening detecting part 155f may be disposed on at least one of inner and outer walls of the gear box 155. For example, the single cover opening detecting part 155f may be disposed on the inner surface of the gear box 155. In this case, the cover opening detecting part 155f may detect that the push protrusion 151 is positioned at the initial position.

As another example, the two cover opening detecting parts 155f may be disposed on the outer surface of the gear box 155. In this case, the cover opening detecting part 155f may detect the initial position and the cover opening position of the push protrusion 151.

Accordingly, according to the present disclosure, the cover opening unit 150 may open the dust bin 220 even though the user separately opens the discharge cover 222 of the cleaner, and as a result, it is possible to improve convenience.

In addition, since the discharge cover 222 is opened in the state in which the cleaner 200 is coupled to the cleaner station 100, it is possible to prevent the dust from scattering.

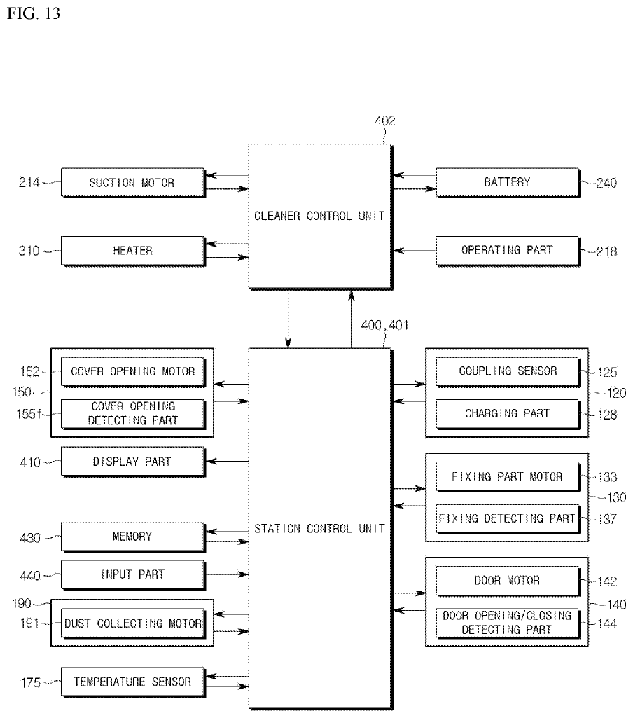

Meanwhile, the dust collecting part 170 will be described below with reference to FIGS. 2 and 13.

The cleaner station 100 may include the dust collecting part 170. The dust collecting part 170 may be disposed in the housing 110. The dust collecting part 170 may be disposed at the lower side of the coupling part 120 based on the gravitational direction.

For example, the dust collecting part 170 may mean a dust bag for collecting dust sucked from the inside of the dust bin 220 of the cleaner 200 by the dust collecting motor 191.

The dust collecting part 170 may be detachably coupled to the housing 110.

Therefore, the dust collecting part 170 may be separated from the housing 110 and discarded, a new dust collecting part 170 may be coupled to the housing 110. That is, the dust collecting part 170 may be defined as a consumable component.

When the suction force is generated by the dust collecting motor 171, a volume of the dust bag is increased, such that the dust may be accommodated in the dust bag.

To this end, the dust bag may be made of a material that transmits air but does not transmit debris such as dust. For example, the dust bag may be made of a non-woven fabric material and have a hexahedral shape when the dust bag has an increased volume.

On the contrary, the dust bag may be made of an impermeable material. For example, the dust bag may include a roll vinyl film (not illustrated). With this configuration, the dust bag is sealed or joined, which may prevent dust or offensive odor captured in the dust bag from leaking to the outside from the dust bag. In this case, the dust bag may be mounted in the housing 110 by means of a dust bag cartridge (not illustrated). As necessary, the dust bag may be replaced by means of the dust bag cartridge.

Meanwhile, a temperature sensor 175 may be provided in the dust collecting part 170. The temperature sensor 175 may measure a temperature in the dust collecting part 170. A control unit 400 may receive information on the temperature measured by the temperature sensor 175.

Meanwhile, according to the embodiment, the temperature sensor 175 may be provided in the dust suction module 190. In case that the temperature sensor 175 is provided in the dust suction module 190, the temperature sensor 175 may measure a temperature of the dust collecting motor 191 or a temperature of air discharged from the dust collecting motor 191, such that a temperature of air flowing to a circulation flow path module 320 may be calculated.

Meanwhile, the flow path part 180 will be described below with reference to FIGS. 2 and 9.

The cleaner station 100 may include the flow path part 180.

The flow path part 180 may connect the dust bin 220 of the cleaner 200 and the dust collecting part 170. The flow path part 180 may allow the dust bin 220 of the cleaner 200 and the dust collecting part 170 to communicate with each other. The flow path part 180 may be disposed at a rear side of the coupling surface 121. The flow path part 180 may mean a space between the dust bin 220 of the cleaner 200 and the dust collecting part 170. The flow path part 180 may be a space formed at a rear side of the dust passage hole 121a. The flow path part 180 may be a flow path bent downward from the dust passage hole 121a, and the dust and the air may flow through the flow path part 180.

Specifically, the flow path part 180 may include a first flow path 181 and a second flow path 182. When the cleaner 200 is coupled to the cleaner station 100 and the dust passage hole 121a is opened, the first flow path 181 may communicate with the internal space of the dust bin 220, and the second flow path 182 may allow the first flow path 181 to communicate with the internal space of the dust collecting part 170.

For example, the first flow path 181 may be disposed to be substantially parallel to an axis of the suction motor 214 or an imaginary through-line that penetrates the dust bin 220. In this case, the axis of the suction motor 214 or the through-line of the dust bin 220 may penetrate the first flow path 181.

In this case, the second flow path 182 may be provided at a predetermined angle with respect to the first flow path 181. For example, an angle between the first flow path 181 and the second flow path 181 may be a right angle. With this configuration, it is possible to minimize an overall volume of the cleaner station 100.

Meanwhile, a length of the first flow path 181 may be equal to or shorter than a length of the second flow path. With this configuration, the suction force of the dust collecting motor 191 may be transmitted to the space in the dust bin 220 even though the entire flow path for removing the dust is bent once.

The dust in the dust bin 220 of the cleaner 200 may move to the dust collecting part 170 through the flow path part 180.

Meanwhile, the dust suction module 190 will be described below with reference to FIGS. 2 and 13.

The cleaner station 100 may include the dust suction module 190. The dust suction module 190 may include the dust collecting motor 191, a first filter 192, and a second filter (not illustrated).

The dust collecting motor 191 may be disposed below the dust collecting part 170. The dust collecting motor 191 may generate a suction force in the flow path part 180. Therefore, the dust collecting motor 191 may provide a suction force capable of sucking the dust in the dust bin 220 of the cleaner 200.

The dust collecting motor 191 may generate the suction force by means of the rotation. For example, the dust collecting motor 191 may be formed in a shape similar to a cylindrical shape.

Meanwhile, in the present embodiment, an imaginary dust collecting motor axis C may be defined by extending the rotation axis of the dust collecting motor 191.

The first filter 192 may be disposed between the dust collecting part 170 and the dust collecting motor 191. The first filter 192 may be a prefilter.

The second filter (not illustrated) may be disposed between the dust collecting motor 191 and the outer wall surface 112. The second filter (not illustrated) may be an HEPA filter.

Meanwhile, the cleaner station 100 may further include a charging part 128. The charging part may be disposed on the coupling part 120. The charging part 128 may be electrically connected to the cleaner 200 coupled to the coupling part 120. The charging part 128 may supply power to the battery of the cleaner 200 coupled to the coupling part 120.

In addition, the cleaner station 100 may further include a lateral door (not illustrated). The lateral door may be disposed in the housing 110. The lateral door may selectively expose the dust collecting part 170 to the outside. Therefore, the user may easily remove the dust collecting part 170 from the cleaner station 100.

In addition, the cleaner station 100 may further include a discharge port 520. The discharge port 520 may be formed in the housing 110. For example, the discharge port 520 may be formed at a lower side of the housing 110 and fluidly connected to the dust collecting motor 191. Therefore, the air passing through the dust collecting motor 191 may be discharged to the outside of the housing 110 through the discharge port 520.

Meanwhile, with reference to FIG. 2, the cleaner station 100 may further include a discharge part 500.

The discharge part 500 may guide the air, which is discharged from the dust collecting motor 191, to the outside of the housing 110 through a discharge flow path 510. That is, the air discharged from the dust collecting motor 191 may flow through the discharge flow path 510 and be discharged to the outside of the housing 110.

The discharge flow path 510 may provide a flow path in which the air discharged from the dust collecting motor 191 flows. Specifically, one end of the discharge flow path 510 may communicate with the internal space of the dust suction module 190, in which the dust collecting motor 191 is accommodated, and the other end of the discharge flow path 510 may communicate with the discharge port 520. For example, the discharge flow path 510 may be a flow path formed in a horizontal direction in the housing 110. One end of the discharge flow path 510 may communicate with the dust suction module 190, and the other end of the discharge flow path 510 may communicate with the discharge port 520.

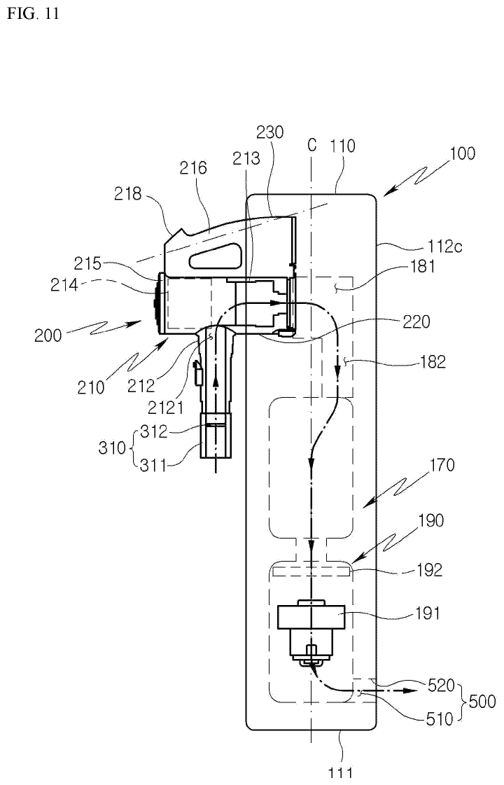

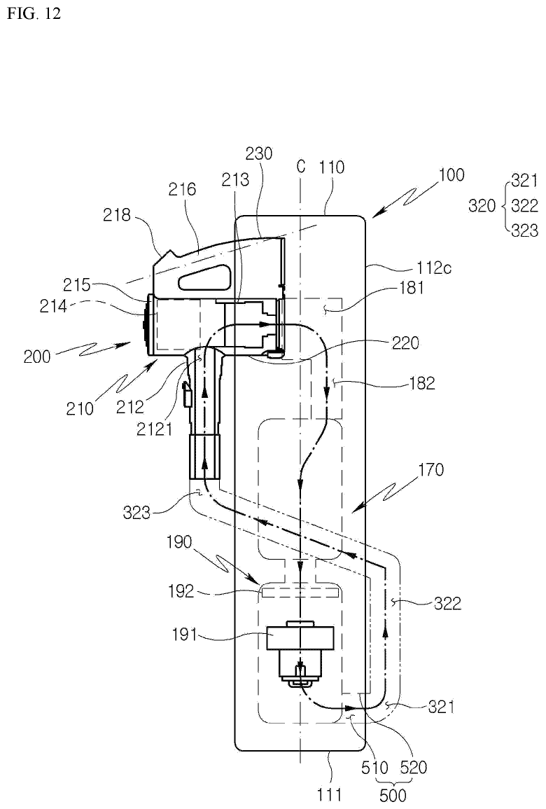

Meanwhile, with reference to FIGS. 11 and 12, the cleaner system 10 may include a heat supply part 300.

The heat supply part 300 may supply heat to the suction part 212. The suction part 212 may receive heat from the heat supply part 300 through the suction flow path 2121 in the suction part 212. The outside heat supplied from the heat supply part 300 may sequentially flow through the suction part 212, the dust bin 220, the flow path part 180, the dust collecting part 170, and the discharge part 500 by the suction force generated by the dust collecting motor 191, and the heat may be discharged to the outside of the housing 110. Therefore, the heat introduced through the suction part 212 may dry the dust collecting part 170, in which dust is captured, while passing through the interior of the dust collecting part 170.

Meanwhile, a cleaner system according to a first embodiment of the present disclosure will be described with reference to FIG. 11.

The heat supply part 300 of the cleaner system according to the first embodiment of the present disclosure may include a heater 310.

The heater 310 may be coupled to the suction part 212. The heater 310 may heat outside air introduced into the suction part 212. The heater 310 may be connected to an inlet side of the suction part 212. However, alternatively, the heater 310 may be disposed in the suction flow path 2121 in the suction part 212. That is, a specific shape or arrangement is not limited as long as the heater may heat the air introduced into the suction part 212.

In case that the heater 310 is connected to the inlet side of the suction part 212, the heater 310 may include a heater housing 311 and a heating element 312.

The heater housing 311 may be separably coupled to the inlet side of the suction part 212 and define a space in which air may flow. For example, the heater housing 311 may be formed in a shape similar to a tubular shape having a flow path in which air flows.

The heating element 312 may be provided along an inner peripheral surface of the heater housing 311. For example, the heating element 312 may be formed in an annular shape along the inner peripheral surface of the heater housing 311. The heating element 312 may heat outside air introduced into the heater housing 311. Therefore, the air heated by the heating element 312 may flow in the dust bin 220 and the dust collecting part 170 and reduce a humidity in the cleaner system 10 including the dust bin 220 and the dust collecting part 170.

The heater 310 may receive power from the battery 240. The battery 240 may supply power to the heater 310. Specifically, the battery 240 may supply power to the heating element 312 configured to heat outside air introduced into the heater housing 311.

The heat, which is heated by the heater 310 and introduced into the suction part 212, may be sucked into the dust collecting part 170 via the dust bin 220 by the suction force generated by the dust collecting motor 191.

The heater 310 may heat the air introduced into the suction part 212 in the state in which the dust collecting motor 191 operates. The heater 310 may heat the air introduced into the suction part 212 when the suction force is provided to the suction part 212 in the state in which the dust collecting motor 191 operates.

For example, the heater 310 may operate when a predetermined time elapses after the operation of the dust collecting motor 191 is initiated. The heater 310 may operate after the dust collecting motor 191 operates for a period of time of 7 seconds or more and 8 seconds or less. However, the present disclosure is not limited thereto. The time may be set and changed depending on an output of the dust collecting motor 191 and a humidity in the dust collecting part 170.

As another example, the heater 310 may operate at the same time when the operation of the dust collecting motor 191 is initiated.

As still another example, the dust collecting motor 191 may operate after the suction part 212 is preheated as the heater 310 operates for a predetermined time. The dust collecting motor 191 may operate after the heater 310 operates for a period of time of 7 seconds or more and 8 seconds or less. However, the present disclosure is not limited thereto. The time may be set and changed depending on a temperature of the air in the suction part 212 preheated by the heater 310 and a humidity in the dust collecting part 170.

The heater 310 may heat the air introduced into the suction part 212 in the state in which the dust passage hole 121a is opened as the door 141 of the cleaner station 100 is rotated. The heater 310 may heat the air introduced into the suction part 212 when the suction force is provided to the suction part 212 in the state in which the door 141 is rotated and the dust passage hole 121a is opened.

Meanwhile, a cleaner system according to a second embodiment of the present disclosure will be described with reference to FIG. 12.

The heat supply part 300 of the cleaner system according to the second embodiment of the present disclosure may include the circulation flow path module 320.

The circulation flow path module 320 may guide the heat, which is discharged from the dust collecting motor 191, to the suction part 212 and continuously circulate the heat between the cleaner 200 and the cleaner station 100 without discharging the heat.

The circulation flow path module 320 may connect the suction part 212 of the cleaner 200 and the discharge part 500 of the cleaner station 100. Specifically, one end of the circulation flow path module 320 may communicate with the suction part 212, and the other end of the circulation flow path module 320 may communicate with the discharge part 500.

The circulation flow path module 320 may provide a flow path (hereinafter, referred to as a ‘circulation flow path’) through which the air discharged through the discharge part 500 may flow. Specifically, one end of the circulation flow path may communicate with the suction flow path 2121 formed in the suction part 212, and the other end of the circulation flow path may communicate with the discharge flow path 510 formed in the discharge part 500.

When the dust collecting motor 191 operates, heat may be generated from the dust collecting motor 191, and the air discharged from the dust collecting motor 191 may be heated by the heat generated by the dust collecting motor 191. The air heated by the dust collecting motor 191 may sequentially pass through the discharge part 500, the circulation flow path module 320, the suction part 212, the dust bin 220, the coupling part 120, the flow path part 180, and the dust collecting part 170 and be introduced into the dust collecting part 170 again, and the air may be repeatedly heated while passing through the dust collecting motor 191. Therefore, a temperature of the air discharged from the dust collecting motor 191 may gradually increase as the air is heated while continuously circulating without being discharged to the outside.

The air discharged from the dust collecting motor 191 may flow through the discharge flow path 510 and be introduced into the circulation flow path module 320. The air introduced into the circulation flow path module 320 may be introduced into the suction flow path 2121 by the airflow discharged from the dust collecting motor 191. The air introduced into the circulation flow path module 320 may be introduced into the suction flow path 2121 by the suction force provided to the dust bin 220 by the dust collecting motor 191. The air introduced into the circulation flow path module 320 may be introduced into the suction flow path 2121 by the airflow discharged by the dust collecting motor 191 and the suction force provided to the dust bin 220 by the dust collecting motor 191.

The air flowing in the circulation flow path module 320 may be introduced into the suction part 212 by the suction force generated by the dust collecting motor 191, and then the air may sequentially pass through the dust bin 220, the coupling part 120, and the flow path part 180 and be introduced into the dust collecting part 170. The air flowing in the circulation flow path module 320 may pass through the dust bin 220, the coupling part 120, and the flow path part 180 by the airflow discharged from the dust collecting motor 191, and then the air may be introduced into the dust collecting part 170. The air flowing in the circulation flow path module 320 may pass through the dust bin 220, the coupling part 120, and the flow path part 180 by the suction force generated by the dust collecting motor 191 and the airflow discharged from the dust collecting motor 191, and then the air may be introduced into the dust collecting part 170.

Specifically, the heat, which flows along the circulation flow path and is introduced into the suction flow path 2121, may sequentially pass through the dust bin 220, the coupling part 120, the first flow path 181, and the second flow path 182 and be introduced into the dust collecting part 170.

The heat introduced into the dust collecting part 170 may dry the dust collecting part 170, in which dust is captured, while passing through the interior of the dust collecting part 170.

The heat, which circulates between the cleaner 200 and the cleaner station 100 by means of the circulation flow path module 320, may be introduced into the dust collecting part 170, thereby reducing a humidity in the cleaner system 10 including the dust collecting part 170. Meanwhile, the interior of the dust collecting part 170 is dried by the heat introduced into the dust collecting part 170 by the circulation flow path module 320, which may remove contamination or offensive odors caused when foreign substances and the like captured in the dust collecting part 170 are left unattended on the dust collecting part 170 over a long period of time.

The circulation flow path module 320 may include a first circulation flow path 321, a second circulation flow path 322, and a third circulation flow path 323.

The air discharged through the discharge flow path 510 may flow through the first circulation flow path 321. For example, the first circulation flow path 321 may be disposed in a direction parallel to a longitudinal direction of the discharge flow path 510. The first circulation flow path 321 may be disposed to be substantially parallel to an imaginary through-line that penetrates the discharge flow path 510. As another example, the first circulation flow path 321 may be formed in a shape bent by a predetermined angle in the horizontal direction from an outlet side of the discharge flow path 510. As still another example, the first circulation flow path 321 may be formed in a direction inclined upward from an outlet side of the discharge flow path 510.

The second circulation flow path 322 may communicate with the first circulation flow path 321, and the air discharged from the first circulation flow path 321 may flow through the second circulation flow path 322. The second circulation flow path 322 may be connected to the first circulation flow path 321 while defining a predetermined angle. For example, the second circulation flow path 322 may be formed in a direction inclined upward from an outlet side of the first circulation flow path 321. The second circulation flow path 322 may be formed in a direction inclined downward from an inlet side of the third circulation flow path 323. As another example, an angle between the second circulation flow path 322 and the first circulation flow path 321 may be a right angle. An angle between the second circulation flow path 322 and the third circulation flow path 323 may be a right angle. Meanwhile, the second circulation flow path 322 may connect the first circulation flow path 321 and the third circulation flow path 323 in a shape bent at least once.

The third circulation flow path 323 may communicate with the second circulation flow path 322, and the air discharged from the second circulation flow path 322 may flow through the third circulation flow path 323. For example, the third circulation flow path 323 may be disposed in a direction parallel to a longitudinal direction of the suction flow path 2121. The third circulation flow path 323 may be disposed to be substantially parallel to an imaginary through-line that penetrates the suction flow path 2121. As another example, the third circulation flow path 323 may be formed in a shape bent by a predetermined angle in the horizontal direction from an inlet side of the suction flow path 2121. As still another example, the third circulation flow path 323 may be formed in a direction inclined downward from the inlet side of the suction flow path 2121. With this configuration, it is possible to minimize a degree to which the suction force of the dust collecting motor 191 and the airflow discharged from the dust collecting motor 191 are reduced in the first circulation flow path 321, the second circulation flow path 322, and the third circulation flow path 323.

Meanwhile, FIG. 13 is a block diagram for explaining a control configuration of the cleaner system according to the embodiment of the present disclosure.

The control configuration of the cleaner system of the present disclosure will be described below with reference to FIG. 13.

The cleaner system 10 according to the embodiment of the present disclosure may further include the control unit 400 configured to control the coupling part 120, the fixing unit 130, the door unit 140, the cover opening unit 150, the dust collecting part 170, the flow path part 180, the dust suction module 190, the suction motor 214, the operating part 218, the battery 240, and the heater 310.

The control unit 400 may include a printed circuit board and elements mounted on the printed circuit board.

The control unit 400 may include a station control unit 401 configured to control the cleaner station 100, and a cleaner control unit 402 configured to control the cleaner 200. The station control unit 401 and the cleaner control unit 402 may exchange information and process data while performing communication. Hereinafter, the station control unit 401 and the cleaner control unit 402 will be referred to collectively as the control unit 400 unless otherwise noted.

When the coupling sensor 125 detects the coupling of the cleaner 200, the coupling sensor 125 may transmit a signal indicating that the cleaner 200 is coupled to the coupling part 120. In this case, the control unit 400 may receive the signal from the coupling sensor 125 and determine that the cleaner 200 is coupled to the coupling part 120.

In addition, when the charging part 128 supplies power to the battery 240 of the cleaner 200, the control unit 400 may determine that the cleaner 200 is coupled to the coupling part 120.

When the control unit 400 determines that the cleaner 200 is coupled to the coupling part 120, the control unit 400 may operate the fixing part motor 133 to fix the cleaner 200.

When the fixing members 131 or the fixing part links 135 are moved to a predetermined dust bin fixing position FP1, a fixing detecting part 137 may transmit a signal indicating that the cleaner 200 is fixed. The station control unit 400 may receive the signal, which indicates that the cleaner 200 is fixed, from the fixing detecting part 137, and determine that the cleaner 200 is fixed. When the control unit 400 determines that the cleaner 200 is fixed, the control unit 400 may stop the operation of the fixing part motor 133.

Meanwhile, when the operation of emptying the dust bin 220 is ended, the control unit 400 may rotate the fixing part motor 133 in the reverse direction to release the cleaner 200.

When the control unit 400 determines that the cleaner 200 is fixed to the coupling part 120, the control unit 400 may operate the door motor 142 to open the door 141 of the cleaner station 100.

When the door 141 or the door arm 143 reaches the predetermined opening position DP1, the door opening/closing detecting part 144 may transmit a signal indicating that the door 141 is opened. The control unit 400 may receive the signal, which indicates that the door 141 is opened, from the door opening/closing detecting part 137 and determine that the door 141 is opened. When the control unit 400 determines that the door 141 is opened, the control unit 400 may stop the operation of the door motor 142.

Meanwhile, when the operation of emptying the dust bin 220 is ended, the control unit 400 may rotate the door motor 142 in the reverse direction to close the door 141.

When the control unit 400 determines that the door 141 is opened, the control unit 400 may operate the cover opening motor 152 to open the discharge cover 222 of the cleaner 200.

When a guide frame 151e reaches the predetermined cover opening position CP1, the cover opening detecting part 155f may transmit a signal indicating that the discharge cover 222 is opened. The control unit 400 may receive the signal, which indicates that the discharge cover 222 is opened, from the cover opening detecting part 155f and determine that the discharge cover 222 is opened. When the control unit 400 determines that the discharge cover 222 is opened, the control unit 400 may stop the operation of the cover opening motor 152.

The control unit 400 may receive information on a temperature in the dust collecting part 170. For example, the control unit 400 may receive information on the temperature in the dust collecting part 170 by means of a temperature sensor 175. The control unit 400 may control the temperature in the dust collecting part 170 on the basis of the temperature information received from the temperature sensor 175.

The control unit 400 may operate the dust collecting motor 191 to suck the dust in the dust bin 220. In addition, the control unit 400 may raise a temperature in the dust collecting part 170 by operating the dust collecting motor 191 and using heat generated from the dust collecting motor 191.

The control unit 400 may operate the heater 310 and heat outside air introduced into the suction part 212. The control unit 400 may heat the air introduced into the suction part 212 by operating the heater 310 in the state in which the dust collecting motor 191 operates.

For example, the control unit 400 may operate the heater 310 when a predetermined time elapses after the operation of the dust collecting motor 191 is initiated. The control unit 400 may operate the heater 310 after operating the dust collecting motor 191 for a period of time of 7 seconds or more and 8 seconds or less. However, the present disclosure is not limited thereto. The time may be set and changed depending on an output of the dust collecting motor 191 and a humidity in the dust collecting part 170.

As another example, the control unit 400 may operate the heater 310 at the same time when the operation of the dust collecting motor 191 is initiated.

As still another example, the control unit 400 may operate the dust collecting motor 191 after preheating the suction part 212 by operating the heater 310 for a predetermined time. The control unit 400 may operate the dust collecting motor 191 after operating the heater 310 for a period of time of 7 seconds or more and 8 seconds or less. However, the present disclosure is not limited thereto. The time may be set and changed depending on a temperature of the air in the suction part 212 preheated by the heater 310 and a humidity in the dust collecting part 170.

In addition, the control unit 400 may heat the air introduced into the suction part 212 in the state in which the dust passage hole 121a is opened as the door 141 of the cleaner station 100 is rotated. Meanwhile, the control unit 400 may control the temperature in the dust collecting part 170 by operating the heater 310 on the basis of the temperature information received from the temperature sensor 175.

The control unit 400 may operate the display part 410 to display a dust bin emptied situation and a charged situation of the cleaner 200.

Meanwhile, the cleaner station 100 according to the present disclosure may include the display part 410.

The display part 410 may be disposed on the housing 110, disposed on a separate display device, or disposed on a terminal such as a mobile phone.

The display part 410 may be configured to include at least any one of a display panel capable of outputting letters and/or figures and a speaker capable of outputting voice signals and sound. The user may easily ascertain a situation of a currently performed process, a residual time, and the like on the basis of information outputted through the display part.

Meanwhile, the cleaner station 100 according to the embodiment of the present disclosure may include a memory 430. The memory 430 may include various data for operating or driving the cleaner station 100.

Meanwhile, the cleaner station 100 according to the embodiment of the present disclosure may include an input part 440. The input part 440 generates key input data inputted by the user to control the operation of the cleaner station 100. To this end, the input part 440 may include a keypad, a dome switch, a touchpad (resistive touchpad/capacitive touchpad), and the like. In particular, in case that the touchpad defines a mutual layer structure together with the display part 410, the touchpad may be called a touch screen.

Hereinafter, a dust collecting step of collecting dust in the dust bin 220 of the cleaner 200 will be described first before the method of controlling the cleaner system according to the embodiment of the present disclosure will be described.

The dust collecting step is a step of introducing the dust in the dust bin 220 into the dust collecting part 170. In the dust collecting step, when the discharge cover 222 is opened and the dust passage hole 121a is opened as the door 141 rotates, the dust collecting motor 191 may operate to collect the dust in the dust bin 220.

The control unit 400 may operate the dust collecting motor 191 when a preset dust collecting waiting time tw elapses after the dust bin 220 is fixed.

For example, the control unit 400 may begin to operate the dust collecting motor 191 when a period of time of 6 seconds or more and 7 seconds or less elapses after the dust bin is fixed. In this case, the control unit 400 may gradually increase a rotational speed of the dust collecting motor 191 to a preset dust collecting speed Ws for a preset suction increase time tsi. For example, the control unit 400 may gradually increase the rotational speed of the dust collecting motor 191 to the dust collecting speed Ws for a period of time of 3 seconds or more and 5 seconds or less. This is advantageous in protecting the dust collecting motor 191 and increasing the lifespan of the dust collecting motor 191 (S51).

In another example, the control unit 400 may begin to operate the dust collecting motor 191 when a period of time of 10 seconds or more and 11 seconds or less elapses after the dust bin is fixed. In this case, the control unit 400 may increase the suction force by increasing the rotational speed of the dust collecting motor 191 to the preset dust collecting speed Ws. This is advantageous in minimizing the operating time of the dust collecting motor 191, improving the energy efficiency, and minimizing the occurrence of noise.

In the dust collecting step, the control unit 400 may operate to rotate the dust collecting motor 191 at the dust collecting speed Ws for a preset dust collecting time ts1. For example, in the dust collecting step, the control unit 400 may operate to rotate the dust collecting motor 191 at the dust collecting speed Ws for a period of time of 14 seconds or more and 16 seconds or less. However, the present disclosure is not limited thereto. The dust collecting time ts1 may be changed and set depending on the output of the dust collecting motor 191 and the amount of dust stored in the dust bin 220.

In the dust collecting step, the dust in the dust bin 220 may pass through the dust passage hole 121a and the flow path part 180 and be collected in the dust collecting part 170. Therefore, the user may remove the dust in the dust bin 220 without a separate manipulation, and as a result, it is possible to provide convenience for the user.

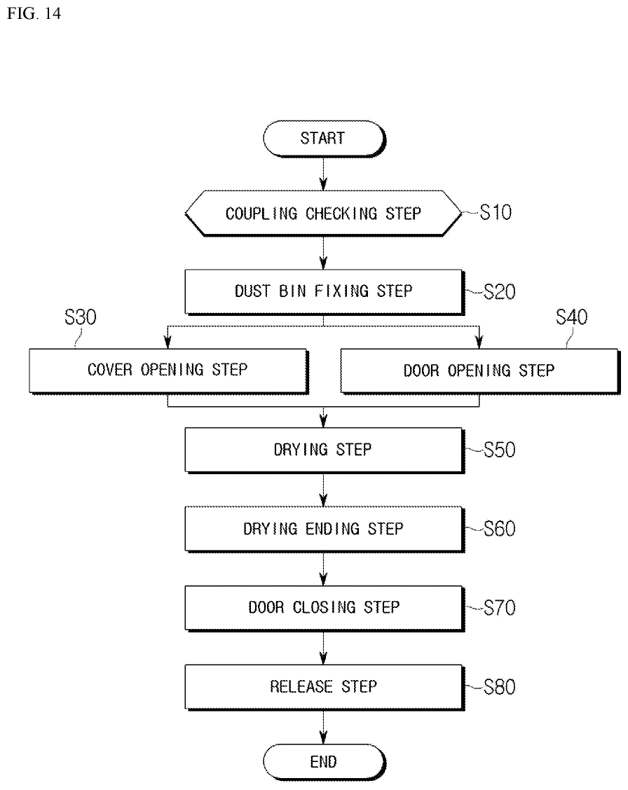

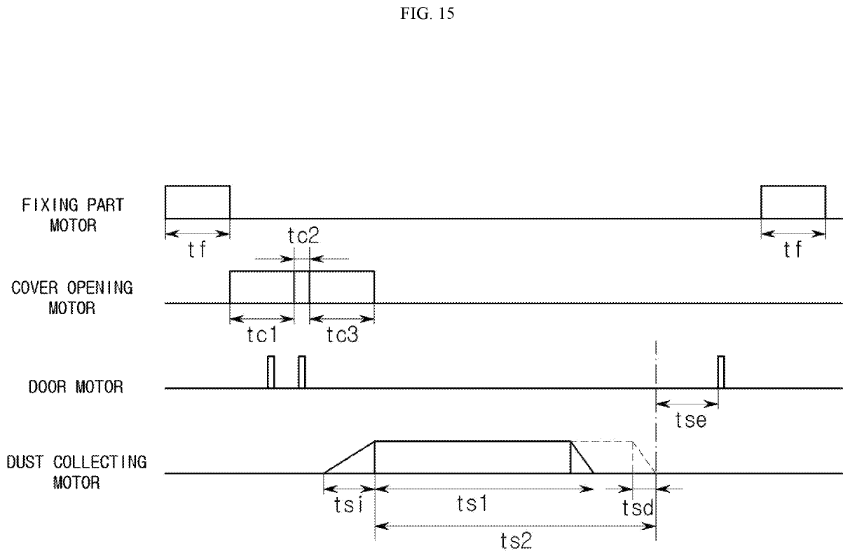

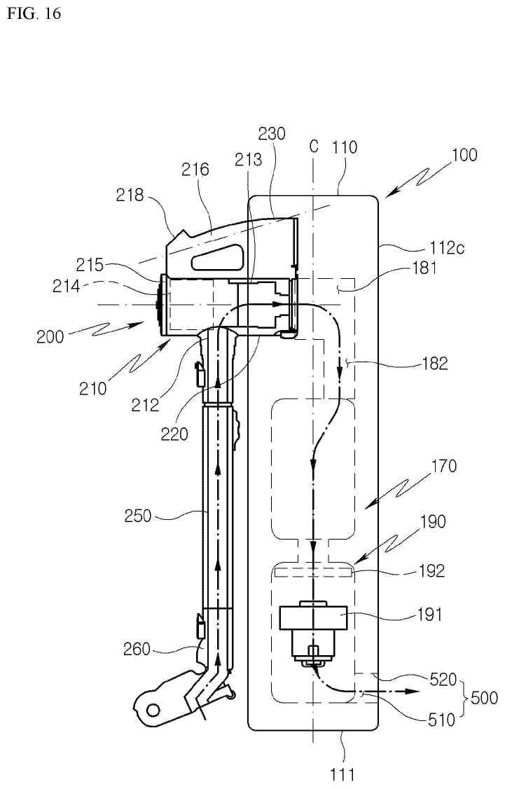

FIG. 14 is a flowchart for explaining a process of drying a dust collecting part in a method of controlling the cleaner system according to the embodiment of the present disclosure, FIG. 15 is a view for explaining operations of the motors in the method of controlling the cleaner system according to the embodiment of the present disclosure, and FIG. 16 is a view for explaining an airflow in a drying step of the method of controlling the cleaner system according to the embodiment of the present disclosure.

The method of controlling the cleaner station according to the embodiment of the present disclosure will be described below with reference to FIGS. 14 to 16.

The method of controlling the cleaner station of the present disclosure includes a coupling checking step S10, a dust bin fixing step S20, a cover opening step S30, a door opening step S40, a drying step S50, a drying ending step S60, a door closing step S70, and a release step S80.

In the coupling checking step S10, whether the cleaner 200 is coupled to the coupling part 120 of the cleaner station 100 may be checked.

Specifically, in the coupling checking step S10, when the cleaner 200 is coupled to the coupling part 120, the coupling sensor 125 disposed on the guide protrusion 123 may come into contact with the battery housing 230, and the coupling sensor 125 may transmit a signal indicating that the cleaner 200 is coupled to the coupling part 120. Alternatively, according to the embodiment, the coupling sensor 125 of a non-contact sensor type disposed on the sidewall 124 may detect the presence of the dust bin 220, and the coupling sensor 125 may transmit a signal indicating that the cleaner 200 is coupled to the coupling part 120.

Therefore, in the coupling checking step S10, the control unit 400 may receive the signal generated by the coupling sensor 125 and determine that the cleaner 200 is coupled to the coupling part 120.

Meanwhile, in the coupling checking step S10 according to the present disclosure, the control unit 400 may determine whether the cleaner 200 is coupled at the exact position on the basis of whether the charging part 128 supplies power to the battery 240 of the cleaner 200.

Therefore, in the coupling checking step S10, the control unit 400 may receive the signal, which indicates that the cleaner 200 is coupled, from the coupling sensor 125, and check whether the charging part 128 supplies power to the battery 240, thereby checking whether the cleaner 200 is coupled to the coupling part 120 of the cleaner station 100.

In the dust bin fixing step S20, when the cleaner 200 is coupled to the cleaner station 100, the fixing member 131 may hold and fix the dust bin 220.

Specifically, when the control unit 400 receives the signal, which indicates that the cleaner is coupled, from the coupling sensor 125, the control unit 400 may operate the fixing part motor 133 in the forward direction so that the fixing member 131 fixes the dust bin 220. In this case, when the fixing members 131 or the fixing part links 135 are moved to the dust bin fixing position FP1, the fixing detecting part 137 may transmit a signal indicating that the cleaner 200 is fixed. Therefore, the control unit 400 may receive the signal, which indicates that the cleaner 200 is fixed, from the fixing detecting part 137, and determine that the cleaner 200 is fixed. When the control unit 400 determines that the cleaner 200 is fixed, the control unit 400 may stop the operation of the fixing part motor 133.

On the contrary, the control unit 400 may stop the operation of the fixing part motor 133 after operating the fixing part motor 133 in the forward direction for a preset fixed time tf. For example, the control unit 400 may stop the operation of the fixing part motor 133 after operating the fixing part motor 133 in the forward direction for a period of time of 4 second or more and 5 seconds or less.

In the cover opening step S30, the control unit 400 may open the discharge cover 222 of the cleaner 200 when the dust bin 220 is fixed to the cleaner station 100.

When the control unit 400 receives a signal, which indicates that the dust bin 220 is fixed, from the fixing detecting part 137, the control unit 400 may open the discharge cover 222 by operating the cover opening motor 152 in the forward direction (S31).

Specifically, the control unit 400 may operate the cover opening motor 152 in the forward direction. As a result, the push protrusion 151 may depart from the initial position and move to the position at which the push protrusion 151 presses the coupling lever 222c. Therefore, the hook engagement between the discharge cover 222 and the dust bin main body 221 is released by the movement of the coupling lever 222c, and the discharge cover 222 is rotated in the direction away from the dust bin main body 221 by the restoring force of the torsion spring 222d, such that the discharge cover 222 may be separated.

Meanwhile, before the push protrusion 151 presses the coupling lever 222c, the cover opening detecting part 155f may transmit a signal indicating that the push protrusion 151 is at the initial position.

When the cover opening motor 152 operates and the push protrusion 151 begins to move to press the coupling lever 222c, the cover opening detecting part 155f may transmit a signal indicating that the push protrusion 151 departs from the initial position. Further, the control unit 400 may receive the signal and determine that the cover opening unit 150 normally operates.

In this case, the control unit 400 may use the timer (not illustrated) to measure the time taken after the cover opening motor 152 is operated in the forward direction or measure the time taken after the push protrusion 151 departs from the initial position.

In this case, the control unit 400 may set and store in advance the time taken until the push protrusion 151 presses the coupling lever 222c after departing from the initial position, based on a rotational speed of the cover opening motor 152 and a movement distance of the push protrusion 151. Therefore, the control unit 400 may operate the cover opening motor 152 in the forward direction for a cover opened time tc1 which is equal to or longer than the time taken until the coupling lever 222c is pressed. For example, the control unit 400 may operate the cover opening motor 152 in the forward direction for a period of time of 4 seconds or more and 5 seconds or less.

Further, after the cover opened time tc1 has elapsed, the control unit 400 may change the rotation direction of the cover opening motor 152 for a preset rotation direction change time tc2 (S32).

Further, after the rotation direction change time tc2 has elapsed, the control unit 400 may operate the cover opening motor 152 in the reverse direction. As a result, the push protrusion 151 may return back to the initial position again (S33).

The control unit 400 may operate the cover opening motor 152 until the cover opening detecting part 155f detects that the push protrusion 151 returns to the initial position. In this case, the control unit 400 may set and store in advance a protrusion return time tc3 taken until the push protrusion 151 returns back to the initial position after the push protrusion 151 pushes the coupling lever 222c. Therefore, the control unit 400 may operate the cover opening motor 152 in the reverse direction for the protrusion return time tc3. For example, the control unit 400 may operate the cover opening motor 152 in the reverse direction for a period of time of 4 seconds or more and 5 seconds or less.

Meanwhile, when the control unit 400 receives, from the cover opening detecting part 155f, the signal indicating that the push protrusion 151 is returned to the initial position, the control unit 400 may end the operation of the cover opening motor 152.

In the door opening step S40, the control unit 400 may open the door 141 when the dust bin 220 is fixed to the cleaner station 100. Meanwhile, the door opening step S40 may be performed simultaneously with the cover opening step S30.

Specifically, when the control unit 400 receives a signal, which indicates that the dust bin 220 is fixed, from the fixing detecting part 137, and the control unit 400 may operate the door motor 142 in the forward direction, such that the door 141 may open the dust passage hole 121a while rotating in the forward direction. That is, in the door opening step S30, the control unit 400 may open the dust passage hole 121a by rotating the door 141.

Meanwhile, in the present embodiment, the control unit 400 may operate the door motor 142 in the forward direction when a preset time elapses after the control unit 400 receives a signal, which indicates that the dust bin 220 is fixed, from the fixing detecting part 137. For example, the control unit 400 may operate the door motor 142 when a period of time of 0.5 second or more and 1.5 seconds or less elapses after the dust bin 220 is fixed.

With this configuration, in the cover opening step S30, the control unit may open the door 141 after waiting the time required for the push protrusion 151 to begin to press the coupling lever 222c, or the control unit may open the discharge cover 222 and the door 141 in a similar timing. Therefore, it is possible to prevent a situation in which in a state in which the door 141 is rotated first and the dust passage hole 121a is opened, the door 141 and the discharge cover 222 strongly collide with each other as the discharge cover 222 is suddenly opened by the restoring force of the torsion spring 222d or a situation in which the door 141 is not opened, and the discharge cover 222 and the dust bin main body 221 are not separated even though the hook engagement between the discharge cover 222 and the dust bin main body 221 is released.

Meanwhile, the control unit 400 may open the dust passage hole 121a by rotating the door 141 in a stepwise manner. Specifically, the control unit 400 may rotate the door 141 by a preset first opening angle θ1 (S41) and then stop the rotation of the door 141 for a preset time (S42). For example, the control unit 400 may rotate the door 141 by 25 degrees or more and 35 degrees or less and then stop the rotation of the door 141 for a period of time of 4 seconds or more and 5 seconds or less.

In this case, the rotation angle of the door 141 may mean an angle by which the door 141 rotates about a hinge shaft hingedly coupled to the housing 110 based on a position at which the door 141 blocks the dust passage hole 121a.

After the rotation of the door 141 is stopped for a preset time, the control unit 400 may further rotate the door 141 by a preset second opening angle θ2. For example, the control unit 400 may further rotate the door 141 by 45 degrees or more and 55 degrees or less (S43).

As a result, when the cover opening step S30 and the door opening step S40 are performed, the discharge cover 222 of the dust bin 220 rotates such that the space in the dust bin main body 221 is opened, and the door 141 rotates such that the dust passage hole 121a is opened. Therefore, the internal space of the dust bin 220 may communicate with the flow path part 180 (specifically, the first flow path 181) of the cleaner station 100.

Meanwhile, when the door arm 143 moves to the preset door opening position DP1, the door opening/closing detecting part 144 may detect the movement and transmit a signal related to the movement. Therefore, the control unit 400 may determine that the door 141 is opened, and the control unit 400 may stop the operation of the door motor 142.

Alternatively, according to the embodiment, the control unit 400 may detect that the door 141 has been sufficiently rotated on the basis of an electric current value applied to the door motor 142. The control unit 400 may determine that the door 141 is opened on the basis of the detection result, and the control unit 400 may stop the operation of the door motor 142.

In the drying step S50, when the discharge cover 222 is opened and the dust passage hole 121a is opened as the door 141 rotates, the dust collecting motor 191 may operate, and the air may be introduced into the dust collecting part 170 so that the dust collecting part 170 in which dust is captured is dried.

In the drying step S50, the control unit 400 may dry the dust collecting part 170 by introducing outside air into the dust collecting part 170 by operating the dust collecting motor 191 for a period of time longer than a period of time for which the control unit 400 operates the dust collecting motor 191 to suck the dust in the dust bin 220 in the dust collecting step.

In the drying step S50, the control unit 400 may operate the dust collecting motor 191 when a preset dust collecting waiting time tw elapses after the dust bin 220 is fixed.

In this case, the control unit 400 may perform control to configure a time ts2 for which the dust collecting motor 191 operates in the drying step S50 so that the time ts2 is longer than a time ts1 for which the dust collecting motor 191 operates in the dust collecting step. For example, in case that the control unit 400 operates the dust collecting motor 191, which rotates at a dust collecting speed Ws, for the time of 14 seconds or more and 16 seconds or less in the dust collecting step, the control unit 400 may operate the dust collecting motor 191, which rotates at the dust collecting speed Ws, for the time of 28 seconds or more and 30 seconds or less in the drying step S50. That is, the time ts2 for which the dust collecting motor 191, which rotates at the dust collecting speed Ws, operates in the drying step S50 may be configured to be longer than the time ts1 for which the dust collecting motor 191, which rotates at the dust collecting speed Ws, operates in the dust collecting step.

As another example, in case that the control unit 400 operates the dust collecting motor 191, which rotates at the dust collecting speed Ws, for the time of 28 seconds or more and 30 seconds or less in the dust collecting step, the control unit 400 may operate the dust collecting motor 191, which rotates at the dust collecting speed Ws, for the time of 56 seconds or more and 60 seconds or less in the drying step S50. However, the present disclosure is not limited thereto. The drying the time ts2 may be set and changed depending on an output of the dust collecting motor 191 and a humidity in the dust collecting part 170.

This is to efficiently dry the interior of the dust collecting part 170 by increasing the operating time of the dust collecting motor 191 to increase a flowing time of the air that is introduced into the suction part 212 and passes through the dust collecting part 170.

The control unit 400 may configure a speed at which the dust collecting motor 191 rotates in the drying step S50 so that the speed at which the dust collecting motor 191 rotates in the drying step S50 is equal to a speed at which the dust collecting motor 191 rotates in the dust collecting step. That is, in the drying step S50, when the dust collecting motor 191 operates, a rotational speed of the dust collecting motor 191 may be maintained as the dust collecting speed Ws. Therefore, a speed at which the dust collecting motor 191 rotates in the drying step S50 may be set to be equal to the dust collecting speed Ws in the dust collecting step. In addition, the operating time of the dust collecting motor 191 in the drying step S50 may be set to be longer than the operating time in the dust collecting step.

In the drying step S50, the control unit 400 may control the operating the time ts2 of the dust collecting motor 191 while maintaining the dust collecting speed Ws of the dust collecting motor 191 in an intact manner in the dust collecting step of sucking the dust in the dust bin 220. In the drying step S50, the control unit 400 may control the rotational speed of the dust collecting motor 191 so that the rotational speed in the drying step S50 is maintained to be equal to the rotational speed of the dust collecting motor 191 in the dust collecting step.

Because the speed at which the dust collecting motor 191 rotates in the drying step S50 is maintained to be equal to the speed at which the dust collecting motor 191 rotates in the dust collecting step, a flow rate of the air passing through the dust passage hole 121a in the drying step S50 may also be maintained to be equal to a flow rate of the air passing through the dust passage hole 121a in the dust collecting step.

Therefore, it is possible to improve the energy efficiency by maintaining the rotational speed of the dust collecting motor 191 in an intact manner and reduce manufacturing costs because a separate drying device for drying the dust collecting part 170 does not need to be provided.

In the drying step S50, the control unit 400 may perform control to configure a flow velocity of the air in the dust bin 220 passing through the dust passage hole 121a so that the flow velocity is equal to a flow velocity of the air in the dust bin 220 passing through the dust passage hole 121a in the dust collecting step.

In the drying step S50, the control unit 400 may perform control to configure the time for which the air in the dust bin 220 passes through the dust passage hole 121a so that the time is longer than the time for which the air in the dust bin passes through the dust passage hole 121a in the dust collecting step.

Meanwhile, the drying step of the method of controlling the cleaner system according to the embodiment of the present disclosure may be a drying step of a method of controlling the cleaner system having the heat supply part 300.

In the drying step S50 of the method of controlling the cleaner system having the heat supply part 300, the control unit 400 may operate the dust collecting motor 191 to introduce the heat, which is supplied from the heat supply part 300, into the dust collecting part 170 in which dust is captured. In the drying step S50, the control unit 400 may operate the dust collecting motor 191 to introduce the heat, which is introduced into the suction part 212, into the dust collecting part 170 in which dust is captured. Specifically, the heat introduced through the suction part 212 may reduce a humidity in the cleaner system including the dust collecting part 170 while sequentially passing through the dust bin 220, the coupling part 120, the flow path part 180, and the dust collecting part 170.

Meanwhile, the method of controlling the cleaner system including the heat supply part 300 according to the embodiment of the present disclosure may have the cleaner system according to the first embodiment of the present disclosure or the cleaner system according to the second embodiment of the present disclosure.

Hereinafter, a method of controlling the cleaner system according to the first embodiment of the present disclosure will be described with reference to FIG. 11.

The cleaner system according to the first embodiment of the present disclosure may include the heater 310. The heater 310 may be coupled to the suction part 212 and heat the air introduced into the suction part 212.

In the drying step S50 of the method of controlling the cleaner system according to the first embodiment of the present disclosure, the control unit 400 may operate the heater 310 and heat the air introduced into the suction part 212. The heat heated by the heater 310 may be introduced into the suction part 212 and reduce the humidity in the cleaner system including the dust collecting part 170 while sequentially passing through the dust bin 220, the coupling part 120, the flow path part 180, and the dust collecting part 170.

In the drying step S50, the control unit 400 may heat the air introduced into the suction part 212 by operating the heater 310 in the state in which the dust collecting motor 191 operates. Specifically, the heater 310 may heat the air introduced into the suction part 212 in the state in which the dust collecting motor 191 operates and the suction force is provided to the suction part 212.

For example, in the drying step S50, the control unit 400 may operate the heater 310 when a predetermined time elapses after the operation of the dust collecting motor 191 is initiated. The control unit 400 may operate the heater 310 after operating the dust collecting motor 191 for a period of time of 7 seconds or more and 8 seconds or less. However, the present disclosure is not limited thereto. The time may be set and changed depending on an output of the dust collecting motor 191 and a humidity in the dust collecting part 170.

As another example, in the drying step S50, the control unit 400 may operate the heater 310 at the same time when the operation of the dust collecting motor 191 is initiated.

As still another example, in the drying step S50, the control unit 400 may operate the dust collecting motor 191 after preheating the suction part 212 by operating the heater 310 for a predetermined time. The control unit 400 may operate the dust collecting motor 191 after operating the heater 310 for a period of time of 7 seconds or more and 8 seconds or less. However, the present disclosure is not limited thereto. The time may be set and changed depending on a temperature of the air in the suction part 212 preheated by the heater 310 and a humidity in the dust collecting part 170.

Meanwhile, in the drying step S50, the control unit 400 may heat the air introduced into the suction part 212 in the state in which the dust passage hole 121a is opened as the door 141 is rotated. Specifically, the heater 310 may heat the air introduced into the suction part 212 in the state in which the door 141 is rotated and the dust passage hole 121a is opened.

Hereinafter, a method of controlling the cleaner system according to the second embodiment of the present disclosure will be described with reference to FIG. 12.

The cleaner system according to the second embodiment of the present disclosure may include the circulation flow path module 320. One end of the circulation flow path module 320 communicates with the suction part 212, and the other end of the circulation flow path module 320 communicates with the discharge part 500, such that the circulation flow path module 320 may guide at least a part of the air, which is to be discharged to the outside of the housing 110 through the discharge part 500, to the suction part 212.

In the drying step S50 of the method of controlling the cleaner system according to the second embodiment of the present disclosure, the control unit 400 may operate the dust collecting motor 191 and heat the air flowing in the cleaner station 100. When the dust collecting motor 191 operates, heat may be generated from the dust collecting motor 191, and the air discharged from the dust collecting motor 191 may be heated by the heat generated by the dust collecting motor 191. The air heated by the dust collecting motor 191 may sequentially pass through the discharge part 500, the circulation flow path module 320, the suction part 212, the dust bin 220, the coupling part 120, and the flow path part 180 and be introduced into the dust collecting part 170 again, and the air may be repeatedly heated while passing through the dust collecting motor 191. Therefore, in the drying step S50, a temperature of the air discharged from the dust collecting motor 191 may gradually increase as the air is heated while continuously circulating without being discharged to the outside.

Therefore, according to the method of controlling the cleaner system according to the embodiment of the present disclosure, room-temperature outside air or heat may be introduced into the dust collecting part 170 to dry the dust collecting part 170 in the drying step S50, which may remove contamination or offensive odors caused when foreign substances and the like captured in the dust collecting part 170 are left unattended on the dust collecting part 170 over a long period of time.

In addition, it is possible to kill insects and microorganisms contained in the dust captured in the dust collecting part 170.

In addition, it is possible to prevent the occurrence of offensive odors caused by the decay of foreign substances captured in the dust collecting part 170.

In the drying ending step S60, the operation of the dust collecting motor 191 may end when the dust collecting motor 191 operates for a predetermined time.

In the drying ending step S60, the control unit 400 may gradually decrease the rotational speed of the dust collecting motor 191 from the dust collecting speed Ws for the preset suction decrease time tsd. For example, the control unit 400 may gradually decrease the rotational speed of the dust collecting motor 191 from the dust collecting speed Ws for a period of time of 1 seconds or more and 3 seconds or less. This is advantageous in protecting the dust collecting motor 191 and increasing the lifespan of the dust collecting motor 191.

On the contrary, the control unit 400 may immediately cut off the power applied to the dust collecting motor 191. This is advantageous in minimizing the operating time of the dust collecting motor 191, improving the energy efficiency, and minimizing the occurrence of noise.

The control unit 400 may be embedded with a timer (not illustrated), and the operation of the dust collecting motor 191 may be ended when the control unit 400 determines that a predetermined time has elapsed.

In this case, the operating time of the dust collecting motor 191 may be preset, or the user may input the operating time through an input part (not illustrated). Alternatively, the control unit 400 may automatically set the operating time by detecting a humidity in the dust collecting part 170 by using a sensor or the like.

In the door closing step S70, the door may be closed after the drying ending step S60.

Specifically, when a preset drying ending time tse elapses after the control unit 400 stops the operation of the dust collecting motor 191, the control unit 400 may operate the door motor 142 in the reverse direction to close at least a part of the dust passage hole 121a. That is, in the door closing step S70, the operation of drying the dust collecting part 170 is ended, and then the door 141 may rotate in the reverse direction to close the dust bin and the hole 121a.

In this case, the discharge cover 222 supported by the door 141 may be rotated by the door 141 and fastened to the dust bin main body 221, such that the lower side of the dust bin main body 221 may be closed.

In this case, when the door arm 143 is moved to the door closed position DP2 at which the door opening/closing detecting part 144 is disposed, the door opening/closing detecting part 144 may transmit a signal indicating that the door 141 is closed.

Therefore, the control unit 400 may receive the signal, which indicates that the door 141 is closed, from the door opening/closing detecting part 144 and determine that the door 141 is closed.

When the control unit 400 determines that the door 141 is closed, the control unit 400 may stop the operation of the door motor 142. With this configuration, the cleaner station 100 may automatically close the door 141 of the cleaner station 100 after the operation of drying the dust collecting part 170 ends.

In the release step S80, when the door 141 is closed in the door closing step S70, the fixing part motor 133 may be operated, such that the fixing member 131 may release the dust bin 220.

Specifically, the control unit 400 may release the dust bin 220 when the control unit 400 receives a signal, which indicates that the door 141 closes the dust passage hole 121a, from the door opening/closing detecting part 144.

That is, when the door arm 143 moves to the preset door closing position DP2, the door opening/closing detecting part 144 may detect the movement and transmit a signal related to the movement. Therefore, the control unit 400 may determine that the door 141 closes the dust passage hole 121a, and the control unit 400 may operate the fixing part motor 133 in the reverse direction to release the dust bin 220.

Alternatively, according to the embodiment, the control unit 400 may detect that the door 141 has been rotated to sufficiently close the dust passage hole 121a on the basis of the electric current value applied to the door motor 142. The control unit 400 may determine that the door 141 has closed the dust passage hole 121a on the basis of the detection result, and the control unit 400 may operate the fixing part motor 133 in the reverse direction to release the dust bin 220.

In this case, when the fixing member 131 or the fixing part link 135 is moved to the releasing position FP2, the fixing detecting part 137 may transmit a signal indicating that the cleaner 200 is released.

Therefore, the control unit 400 may receive the signal, which indicates that the cleaner 200 is released, from the fixing detecting part 137 and determine that the cleaner 200 is released.

When the control unit 400 determines that the cleaner 200 is released, the control unit 400 may stop the operation of the fixing part motor 133.

With this configuration, when the dust passage hole 121a are closed by the door 141 of the cleaner station 100 and the discharge cover 222 of the dust bin 220 is closed, the flow path connection between the flow path part 180 of the cleaner station 100 and the internal space of the dust bin 220 are blocked, such that the dust bin 220 may be released, and the user may separate the cleaner 200 from the cleaner station 100.

According to the embodiment of the present disclosure, the outside air or heat is introduced into the dust collecting part 170 in the drying step S50, which may remove contamination or offensive odors caused when foreign substances and the like captured in the dust collecting part 170 are left unattended on the dust collecting part 170 over a long period of time.

While the present disclosure has been described with reference to the specific embodiments, the specific embodiments are only for specifically explaining the present disclosure, and the present disclosure is not limited to the specific embodiments. It is apparent that the present disclosure may be modified or altered by those skilled in the art without departing from the technical spirit of the present disclosure.

All the simple modifications or alterations to the present disclosure fall within the scope of the present disclosure, and the specific protection scope of the present disclosure will be defined by the appended claims.

1. A cleaner system comprising:
a cleaner comprising a dust bin, and a suction part configured to guide outside air containing dust into the dust bin;
a cleaner station comprising a housing in which a coupling part onto which the cleaner is seated and coupled is disposed, a dust collecting part accommodated in the housing, disposed at a lower side of the coupling part, and configured to capture dust in the dust bin, a flow path part configured to connect the dust collecting part and a dust passage hole formed in the coupling part, a dust collecting motor disposed below the dust collecting part and configured to generate a suction force so that the dust is introduced into the dust collecting part through the flow path part, and a discharge part configured to guide air, which is discharged from the dust collecting motor, to the outside of the housing; and
a heat supply part configured to supply heat to the suction part.

2. The cleaner system of claim 1, wherein the heat supply part comprises a heater coupled to the suction part and configured to heat outside air introduced into the suction part.

3. The cleaner system of claim 2, wherein the heater heats outside air introduced into the suction part in a state in which the dust collecting motor operates.

4. The cleaner system of claim 2, wherein the heater heats outside air introduced into the suction part in a state in which a door of the cleaner station is rotated and the dust passage hole is opened.

5. The cleaner system of claim 1, wherein the heat supply part comprises a circulation flow path module having one end configured to communicate with the suction part, and the other end configured to communicate with the discharge part, such that the heat supply part guides at least a part of air, which is to be discharged to the outside of the housing through the discharge part, to the suction part.

6. A method of controlling a cleaner system, the method comprising:
a door opening step of opening a dust passage hole by rotating a door of a cleaner station to which a cleaner is coupled; and
a drying step of drying a dust collecting part of the cleaner station, in which dust is captured, by introducing air into the dust collecting part by operating a dust collecting motor of the cleaner station in a state in which the dust passage hole is opened.

7. The method of claim 6, wherein a time for which the dust collecting motor operates in the drying step is set to be longer than a time for which the dust collecting motor operates in a dust collecting step of collecting dust in a dust bin of the cleaner.

8. The method of claim 6, wherein a rotational speed of the dust collecting motor in the drying step is set to be equal to a rotational speed of the dust collecting motor in a dust collecting step of collecting dust in a dust bin of the cleaner.

9. The method of claim 6, wherein in the drying step, a heater, which heats outside air introduced into a suction part of the cleaner, operates in a state in which the dust collecting motor operates.

10. A method of controlling a cleaner system, the method comprising:
a dust bin fixing step of fixing a dust bin of a cleaner when the cleaner is coupled to a cleaner station;
a door opening step of opening a dust passage hole by rotating a door of the cleaner station in a forward direction when the dust bin is fixed;
a drying step of drying a dust collecting part of the cleaner station, in which dust is captured, by introducing air into the dust collecting part by operating a dust collecting motor of the cleaner station in a state in which the dust passage hole is opened;
a door closing step of closing the dust passage hole by rotating the door in a reverse direction after an operation of the dust collecting motor ends after the dust collecting motor operates for a predetermined time; and
a release step of releasing the dust bin when the door is closed.
